(19) United States
(12) Patent Application Publication
(10) Pub. No.: US 2025/0220664 A1
(43) Pub. Date: Jul. 3, 2025

(54) SCHEDULING USER DEVICES IN GROUPS

(71) Applicant: Apple Inc., Cupertino, CA (US)

(72) Inventors: Christian Hofmann, Munich (DE); Ahmed Mohamed Ibrahim Hassan, Munich (DE); Amr Abdelrahman Yousef Abdelrahman Mostafa, Munich (DE); Dimitrios Alanis, Munich (DE); Milan Zivkovic, Munich (DE); Nikolai Bijovski Ribakov, Munich (DE); Panagiotis Botsinis, Munich (DE); Said Medjkouh, San Diego, CA (US); Sameh M. Eldessoki, Munich (DE); Tarik Tabet, Carlsbad, CA (US)

(21) Appl. No.: 19/001,188

(22) Filed: Dec. 24, 2024

(30) Foreign Application Priority Data
Dec. 29, 2023 (GR) 20230101084

(51) Int. Cl. H04W 72/121

(52) U.S. Cl. CPC H04W 72/121

(57) ABSTRACT

A method includes receiving one or more requests to register a first user equipment (UE) and a second UE in a device group. The method includes obtaining, from the one or more requests, information about a plurality of UEs in the device group and a plurality of data flows corresponding to the plurality of UEs. The information includes dependency information between a first data flow and a second data flow of the plurality of data flows. The method includes sending, to a base station, instructions to configure the device group. The instructions include scheduling information for the first UE and the second UE.

### CROSS-REFERENCE TO RELATED APPLICATION

This application claims priority to and the benefit of Greek patent application Ser. No. 20230101084, filed on Dec. 29, 2023, which is incorporated herein by reference in its entirety.

### BACKGROUND

Wireless communication networks provide integrated communication platforms and telecommunication services to wireless user devices. Example telecommunication services include telephony, data (e.g., voice, audio, and/or video data), messaging, and/or other services. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time division multiple access (TDMA) networks, frequency-division multiple access (FDMA) networks, orthogonal frequency-division multiple access (OFDMA) networks, Long Term Evolution (LTE), Fifth Generation New Radio (5G NR), and Sixth Generation (6G) cellular networks, among others. The wireless communication networks facilitate mobile broadband service using technologies such as OFDM, multiple input multiple output (MIMO), advanced channel coding, massive MIMO, beamforming, and/or other features.

In cellular communications, a user device, such as a user equipment (UE), communicates with a wireless access node, such as a base station, using radio resources of a radio access network (RAN). Similarly, in sidelink communications, a UE directly communicates with another UE using radio resources for sidelink communications. In Mode 1 of sidelink communications, the sidelink communication resources are allocated by a base station, whereas in Mode 2 of sidelink communications, the sidelink communication resources are allocated by a UE in the sidelink communication. The process of allocating communication resources generally involves scheduling.

### SUMMARY

In accordance with one aspect of the present disclosure, a method is provided. The method includes receiving one or more requests to register a first UE and a second UE in a device group, wherein the device group corresponds to a common application executed by the first UE and the second UE. The method includes obtaining, from the one or more requests, information about a plurality of UEs in the device group and a plurality of data flows corresponding to the plurality of UEs. The information includes dependency information between a first data flow and a second data flow of the plurality of data flows. The method includes sending, to a base station, instructions to configure the device group. The instructions include scheduling information for the first UE and the second UE. The scheduling information is based on at least the dependency information.

In accordance with another aspect of the present disclosure, a method is provided. The method includes receiving one or more requests to register a first UE and a second UE in a device group. The method includes obtaining, from the one or more requests, information about a first data flow and a second data flow. The first data flow and the second data flow are associated with communication in the device group. The method includes determining a timing constraint corresponding to the device group based on the first data flow and the second data flow. The timing constraint is applied between packets of the first data flow and the second data flow, packet bursts of the first data flow and the second data flow, or protocol data unit (PDU) sets of the first data flow and the second data flow. The method includes scheduling the first data flow and the second data flow based on the timing constraint. The method includes controlling transmission of the first data flow and the second data flow (i) to the first UE and the second UE, respectively, or (ii) both to the first UE, according to the scheduling.

In accordance with another aspect of the present disclosure, a method is provided. The method includes obtaining, from at least one of a first UE and a second UE, dependency information between a first data flow to be received by the first UE and a second data flow to be received by the second UE. The method includes transmitting, to a base station, a request to register the first UE and the second UE in a device group, wherein the request includes the dependency information. The method includes receiving, from the base station, a configuration of the device group, the configuration including a timing constraint between the first data flow and the second data flow based at least on the dependency information. The method includes scheduling, based on the timing constraint, transmission of the first data flow and the second data flow. The method includes controlling, according to the scheduling, the transmission of the first data flow and the second data flow to the first UE and the second UE, respectively.

In accordance with another aspect of the present disclosure, a method is provided. The method includes transmitting, to a plurality of UEs, group assignment configuration information indicating a plurality of radio resource assignment parameters respectively dedicated to the plurality of UEs. The method includes assigning the plurality of UEs to a device group. The method includes transmitting, to the plurality of UEs in the device group, a group assignment message. The method includes causing the plurality of UEs to communicate with the base station based at least on the plurality of radio resource assignment parameters.

In accordance with another aspect of the present disclosure, a method is provided. The method includes receiving group assignment configuration information from a base station, wherein the group assignment configuration information indicates one or more radio resource assignment parameters. The method includes receiving a grouping message from the base station. The grouping message assigns the UE to a device group including one or more other UEs. The grouping message associates the UE with the one or more radio resource assignment parameters. The method includes receiving a group assignment message from the base station. The method includes, in response to the group assignment message, communicating with the base station based at least on the one or more radio resource assignment parameters.

The details of one or more implementations of these systems and methods are set forth in the accompanying drawings and the description below. Other features, objects, and advantages of these systems and methods will be apparent from the description and drawings, and from the claims.

### BRIEF DESCRIPTION OF THE FIGURES

FIG. 1 illustrates a wireless network, according to some implementations.

FIGS. 2A-2D each illustrate an example architecture of a wireless network in which multiple UEs are scheduled as a group, according to some implementations.

FIG. 3 illustrate example processing of data flows corresponding to two UEs, according to some implementations.

FIGS. 4A-4C each illustrate an example procedure of forming a device group, according to some implementations.

FIG. 5 illustrates an example procedure of group setup, according to some implementations.

FIGS. 6A and 6B each illustrate an example procedure of group member measurement, according to some implementations.

FIG. 7 illustrates an example wireless network with a group of UEs, according to some implementations.

FIGS. 8A and 8B each illustrate an example procedure of group assignment, according to some implementations.

FIGS. 9A-9E illustrate flowcharts of example methods for device group communication, according to some implementations.

FIG. 10 illustrates an example UE, according to some implementations.

FIG. 11 illustrates an example access node, according to some implementations.

### DETAILED DESCRIPTION

A wireless network may have multiple UEs in communication with one another and/or in communication with a base station. In some scenarios, multiple UEs within close proximity of each other can have similar radio channel conditions. Additionally or alternatively, multiple UEs can perform wireless communications in a coordinated manner. As an example, in applications of augmented reality (AR), virtual reality (VR), or mixed reality, which are collectively referred to as “XR,” multiple UEs can jointly perform wireless communications with an application server via a RAN or via device-to-device (D2D) links. The channel resources used by these UEs can be similar, and the data transmitted and received by these UEs can have alignment similarities. Furthermore, when multiple UEs each running the same application communicate data flows, e.g., service data flows (SDFs), with an application server, or when a UE communicates multiple SDFs in the same application with an application server, the multiple SDFs may need to be communicated under certain time constraints due to the inter-dependency among the SDFs. For example, when a user plays a VR game while wearing a headset and holding a joystick, the SDFs representing audio data, image data, and motion data may need to be synchronized when separately transmitted to the headset and the joystick. Because different UEs may process SDFs at different rates or speeds, and because the time between transmission and reception of the SDFs may differ for different UEs, it is desirable to schedule the SDF transmissions, and likewise, receptions, in a coordinated manner such that the processing capability and the transmission delay associated with individual UEs are taken into account. The SDFs with inter-dependency and alignment requirements are referred to as multi-modal data flows.

In addition, when a base station coordinates the scheduling of SDF transmissions or receptions to and from multiple UEs that have a group relationship, the base station signals each UE to provide configurations needed for the SDF transmissions or receptions. Such signaling, if individually conducted, may consume considerable network resources and potentially cause congestion, especially when the number of UEs is large. Accordingly, it is desirable to have a mechanism that can simplify the signaling.

This disclosure provides techniques that allow coordinated scheduling of multiple UEs in a group. As discussed below, implementations of this disclosure provide a device group function (DGF), which can be a network entity implemented as software or hardware that operates along with other network functions of a cellular core network (CN) to manage the setup, registration, and scheduling of a group of UEs that have SDF alignment requirements. Implementations of this disclosure also allow a base station to provide radio resource assignment parameters to a group of UEs in a single message, which can reduce signal overhead.

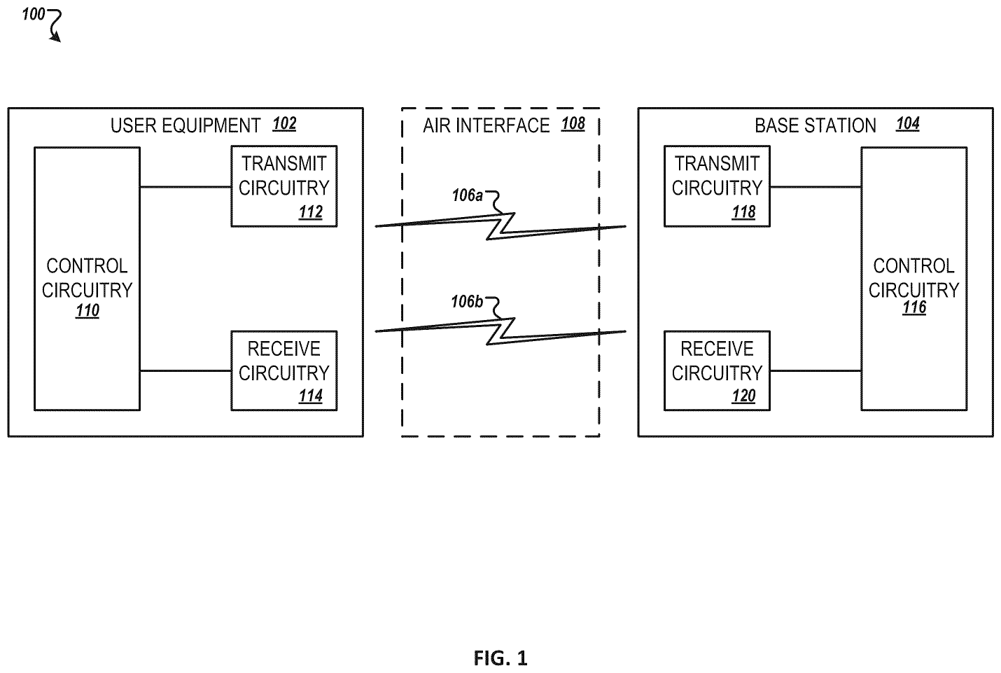

FIG. 1 illustrates a wireless network 100, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be a E-UTRA (Evolved Universal Terrestrial Radio Access)-NR Dual Connectivity (EN-DC) network, or an NR-EUTRA Dual Connectivity (NE-DC) network. In some other implementations, the wireless network 100 may be a Standalone (SA) network that incorporates only 5G NR. Furthermore, other types of communication standards are possible, including future 3GPP systems (e.g., Sixth Generation (6G)), Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, any of laptop computers, smartphones, tablet computers, machine-type devices such as smart meters or specialized devices for healthcare, intelligent transportation systems, or any other wireless device. In network 100, the base station 104 provides the UE 102 network connectivity to a broader network (not shown). This UE 102 connectivity is provided via the air interface 108 in a base station service area provided by the base station 104. In some implementations, such a broader network may be a wide area network operated by a cellular network provider, or may be the Internet. Each base station service area associated with the base station 104 is supported by one or more antennas integrated with the base station 104. The service areas can be divided into a number of sectors associated with one or more particular antennas. Such sectors may be physically associated with one or more fixed antennas or may be assigned to a physical area with one or more tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application-specific circuitry and baseband circuitry. The transmit circuitry 112 and receive circuitry 114 may be adapted to transmit and receive data, respectively, and may include radio frequency (RF) circuitry and/or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations, such as those described elsewhere in this disclosure related to a UE. For instance, the control circuitry 110 can process the device group configurations received from base station 104 and control the transmit circuitry 112 and the receive circuitry 114 to perform communication in the device group.

The transmit circuitry 112 can perform various operations described in this specification. For example, the transmit circuitry 112 may transmit using a plurality of multiplexed uplink physical channels. The plurality of uplink physical channels may be multiplexed, e.g., according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. For instance, the receive circuitry 114 may receive a plurality of multiplexed downlink physical channels from the air interface 108 and relay the physical channels to the control circuitry 110. The plurality of downlink physical channels may be multiplexed, e.g., according to TDM or FDM along with carrier aggregation. The transmit circuitry 112 and the receive circuitry 114 may transmit and receive, respectively, both control data and content data (e.g., messages, images, video, etc.) structured within data blocks that are carried by the physical channels.

FIG. 1 also illustrates the base station 104. In some implementations, the base station 104 may be a 5G radio access network (RAN), a next generation RAN, a E-UTRAN, a non-terrestrial cell, or a legacy RAN, such as a UTRAN. As used herein, the term “5G RAN” or the like may refer to the base station 104 that operates in an NR or 5G wireless network 100, and the term “E-UTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The receive circuitry 120 may receive a plurality of uplink physical channels from one or more UEs, including the UE 102.

In FIG. 1, the one or more channels 106A, 106B are illustrated as an air interface to enable communicative coupling, and can be consistent with cellular communications protocols, such as a UMTS protocol, a 3GPP LTE protocol, an Advanced long term evolution (LTE-A) protocol, a LTE-based access to unlicensed spectrum (LTE-U), a 5G protocol, a NR protocol, an NR-based access to unlicensed spectrum (NR-U) protocol, and/or any other communications protocol(s). In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Discovery Channel (PSDCH), and a Physical Sidelink Broadcast Channel (PSBCH).

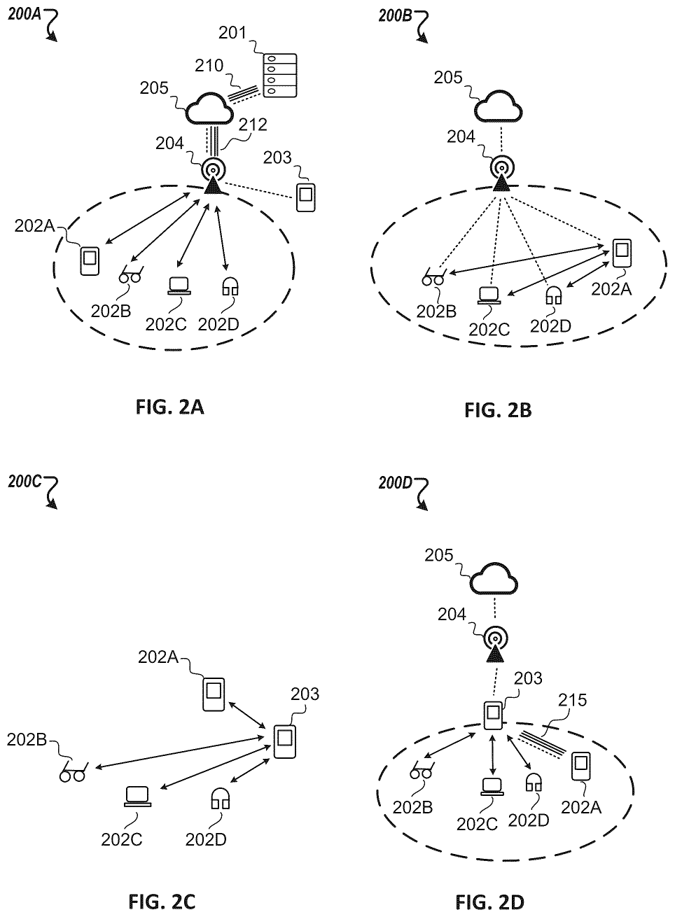

FIGS. 2A-2D each illustrate an example architecture of a wireless network in which multiple UEs 202A-202D (collectively UEs 202) and 203 are scheduled as a group, according to some implementations. UEs 202 and 203 can be similar to UE 102 of FIG. 1. FIGS. 2A, 2B, and 2D also show base station 204, which can be similar to base station 104 of FIG. 1. UEs 202 and 203 can be, e.g., wearable XR devices configured to execute a common XR application.

In architecture 200A of FIG. 2A, base station 204 communicates with UEs 202 and 203 to provide network service supplied by CN 205. In particular, CN 205 obtains application data from application server 201 and provides multiple SDFs 212 to base station 204 for transmission to UEs 202. By grouping UEs 202, the scheduling of the SDF transmissions can be coordinated by a DGF and performed by base station 204 with the assistance of UE 203. For example, UE 203 can serve as a management node that, e.g., collects processing capability information from UEs 202, requests the DGF to register UEs 202 as a device group, sets up the device group based on configurations from the DGF, and performs measurements with UEs 202.

The DGF can be implemented within CN 205 as one of the network functions, or implemented within base station 204. When the DGF is implemented within CN 205, CN 205 can receive one or more device group registration requests from base station 204, which obtains the device group registration requests either directly from each of UEs 202 or via the management node of UE 203. When the DGF is implemented within base station 204, base station 204 obtains the device group registration requests and provides the information indicated in the device group registration requests to the DGF.

The device group registration requests can provide the DGF with a variety of information. The information can include, e.g., an identifier (ID) of each of UEs 202, inter-dependencies between UEs 202, processing capabilities of UEs 202, and SDFs that each of UEs 202 expects to communicate. The device group registration requests can also indicate inter-dependencies between SDFs and whether the inter-dependent SDFs are communicated with the same UE or multiple UEs. In some implementations, the indication about the SDFs further specifies the types (e.g., audio or video), formats (e.g., a stream of packets, packet bursts, or protocol data unit (PDU) sets), sizes (e.g., number of packets, packet bursts, or PDUs of a SDF) of the SDFs, and one or more quality of service (QOS) parameters associated with the SDFs or associated with UEs 202.

The QoS parameters obtained by the DGF can include timing constraints for inter-dependent SDFs, such as the maximum delay between receptions of two inter-dependent SDFs. The timing constraints can specify a scheduling policy for late-arriving SDFs. Alternatively or additionally, the QoS parameters can include jitter constraints specific to SDFs or to the UEs, and/or priority information of the SDFs.

Based on the information from the device group registration requests, the DGF can determine to group UEs 202. The DGF can assign an ID to the device group, associate each of UEs 202 with the group ID, and provide the associations to other network functions of CN 205, such as session management function (SMF) and user plane function (UPF). After a device group is created, the DGF can add another UE to the device group or remove a UE from the device group. When multiple device groups are created, the DGF can configure a UE to switch between device groups. The DGF can also configure UEs 202 within the device group to perform and report measurements, such that the RAN can have up-to-date information when making scheduling and/or mobility decisions. For example, the DGF can configure a UE in the device group to measure and report, periodically or when triggered by an event, the propagation delay and/or the processing delay of the UE. Similarly, the DGF can configure each UE in the device group to measure and report, periodically or when triggered by an event, vicinity and/or quasi-colocation (QCL) information of the UE with respect to the RAN. Such information can include the UE's distance and motion information and/or the channel condition with respect to base station 204 or UE 203. In some implementations, the DGF facilitates information exchange between UEs 202 within the device group by routing the information from one UE to another.

In architecture 200B of FIG. 2B, UEs 202 perform Mode 1 sidelink communications using resources scheduled by base station 204. Different from architecture 200A in which the SDFs are provided by application server 201, architecture 200B does not involve an application server to provide SDFs. Instead, each of UEs 202B-202D establishes a D2D link with UE 202A to communicate SDFs in the sidelink communications.

In architecture 200B, the DGF can be similarly implemented within CN 205 as one of the network functions, or implemented within base station 204. To form a device group having UEs 202, base station 204 can obtain the device group registration requests directly from UEs 202, or via the management node of UE 202A. The functions and operations of the DGF in architecture 200B are similar to those described above in architecture 200A and are thus omitted for brevity.

In architecture 200C of FIG. 2C, UEs 202 perform Mode 2 sidelink communications using resources scheduled by UE 203 without involvement of a base station. In this case, the DGF can be implemented within UE 203, which can form a group including UEs 202 based on device group registration requests received from UEs 202. Based on information received from UEs 202, the DGF can schedule communications of SDFs with UEs 202 by performing operations similar to those performed by the DGFs in architectures 200A and 200B.

In architecture 200D of FIG. 2D, UE 203 receives network service from CN 205 via base station 204. UE 203 operates a subnetwork, e.g., as a hotspot, that allows UEs 202 to communicate locally, e.g., without going through the RAN of base station 204. In the local communications, UE 202A can execute an application that communicates SDFs with UEs 202B-202D via UE 203 as a management node. In this architecture, the DGF can be implemented within UE 203, which forms a group including all of UEs 202 or including UEs 202B-202D only. The DGF in architectures 200D can perform operations similar to those performed by the DGFs in architectures 200A-200C.

As described above, multi-modal SDFs may be subject to alignment requirements, such as time constraints, due to the inter-dependency between the SDFs. For SDFs communicated with the same UE, the inter-dependency results in cross-SDF time constraints. For SDFs communicated with different UEs, the inter-dependency results in cross-UE time constraints. The time constraints can be applied between corresponding packets, between corresponding packet bursts, or between corresponding PDU sets of inter-dependent SDFs. For example, the time constraints can specify a maximum time difference between the reception of a packet (or a packet burst or a PDU set) in a first SDF towards a first UE and the reception of a corresponding packet (or a packet burst or a PDU set) in a second SDF towards a second UE. The time constraints can further specify that when the delay between the two receptions is longer than a threshold, either the late reception or both receptions should be discarded as invalid. Regardless of whether the time constraints are cross-SDF or cross-UE, a DGF according to implementations is configured to schedule the SDFs in a coordinated manner with the time constraints taken into account.

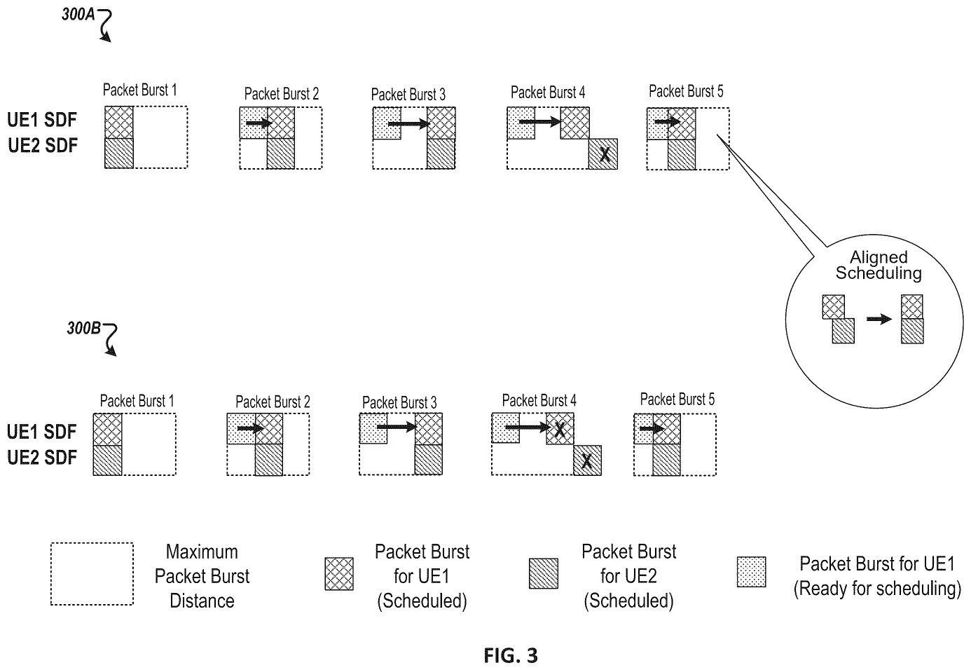

FIG. 3 illustrate example processing of data flows corresponding to two UEs, UE1 and UE2, according to some implementations. In scenarios 300A and 300B of FIG. 3, a DGF schedules five packet bursts, numbered packet burst 1 to packet burst 5, to each of UE1 and UE2, subject to time constraints in the form of maximum packet burst distance (MPBD). MPBD, in this example, specifies a time window that begins when a packet burst in an SDF is ready for transmission to a UE ahead of the time when a corresponding packet burst in the other SDF is ready.

In scenario 300A, packet bursts 1 for both UE1 SDF and UE2 SDF are ready for transmission at the same time, satisfying the time constraints. Accordingly, the DGF can schedule transmissions of packet bursts 1 for UE1 SDF and UE2 SDF at the same time.

Also in scenario 300A, packet burst 2 for UE2 SDF is ready for transmission immediately after when packet burst 2 for UE1 SDF is ready for transmission. Despite the delay, both packet bursts are ready within the time window specified by the MPBD. Accordingly, the DGF can hold packet burst 2 for UE1 SDF to be aligned with UE2 SDF and schedule transmissions of packet bursts 2 for UE1 SDF and UE2 SDF at the same time.

Also in scenario 300A, packet burst 3 for UE2 SDF is ready for transmission after when packet burst 3 for UE1 SDF is ready for transmission. Although the delay is longer for packet burst 3 than packet burst 2 described above, packet bursts 3 for UE1 SDF and UE2 SDF are ready within the time window specified by the MPBD. Accordingly, the DGF can hold packet burst 3 for UE1 SDF to be aligned with UE2 SDF and schedule transmissions of packet bursts 3 for UE1 SDF and UE2 SDF at the same time.

Also in scenario 300A, packet burst 4 for UE2 SDF is ready for transmission after when packet burst 4 for UE1 SDF is ready for transmission. Here, the delay is longer than the maximum allowed by the MPBD, which means packet burst 4 for UE2 SDF is ready outside of the time window. Accordingly, the DGF can schedule transmission of packet burst 4 for UE1 SDF at the end of the time window while discarding the late-arriving packet burst 4 for UE2 SDF.

Also in scenario 300A, packet burst 5 for UE2 SDF is ready for transmission after when packet burst 5 for UE1 SDF is ready for transmission. The delay is minimal and can be caused by jitters. Both packet bursts are ready within the time window specified by the MPBD. Accordingly, the DGF can hold packet burst 5 for UE1 SDF to be aligned with UE2 SDF and schedule transmissions of packet bursts 5 for UE1 SDF and UE2 SDF at the same time to account for, e.g., the processing speed difference between the two UEs or the propagation delay difference over paths to the two UEs. This can be similar to the adjustment to packet burst 3 for UE1 SDF.

In scenario 300B, the scheduling for packets 1, 2, 3, and 5 is the same as that described in scenario 300A. For packet burst 4 of UE1 SDF, different from scenario 300A, the DGF in scenario 300B discards both packet burst 4 of UE1 SDF and packet burst 4 of UE2 SDF. In other words, the discard of a late-arriving packet burst in scenario 300A does not cause the discard of a corresponding packet burst in an inter-dependent SDF, where, by contrast, the discard of a late-arriving packet burst in scenario 300B causes a corresponding packet burst in an inter-dependent SDF to be discarded as well. Whether a DGF adopts the scheduling of scenario 300A or 300B can be dependent on, e.g., the nature of the SDFs and/or the requirements of the UEs, which can be indicated to the DGF when the UEs send their device group registration requests.

Although the packet bursts shown in scenario 300A or 300B have the same size, it is possible that packet bursts (or packets or PDU sets) of inter-dependent SDFs have different sizes. In these cases, the DGF can take into account the different sizes when determining the MPBD. Alternatively or additionally, it is possible that inter-dependent SDFs have different priorities with respect to alignment. For example, it is possible that packet bursts (or packets or PDU sets) of a high priority SDF can be scheduled even with corresponding packet bursts (or packets or PDU sets) of an inter-dependent low priority SDF discarded due to late arrival. On the other hand, it can be specified that packet bursts (or packets or PDU sets) of a low priority SDF should be discarded when corresponding packet bursts (or packets or PDU sets) of an inter-dependent high priority SDF are discarded due to late arrival. The DGF can obtain these priority settings and priority information of the SDFs from, e.g., device group registration requests, and make scheduling decisions accordingly. Other parameters that the DGF can use in the scheduling include sizes and intervals of the packets, packet bursts, or PDU sets in the SDFs.

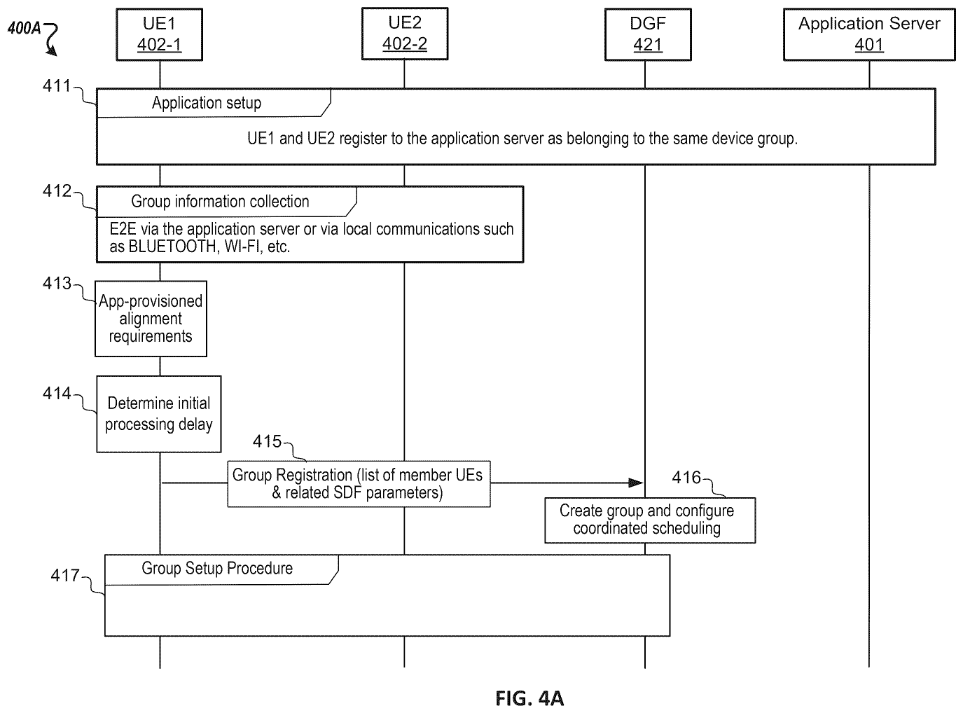

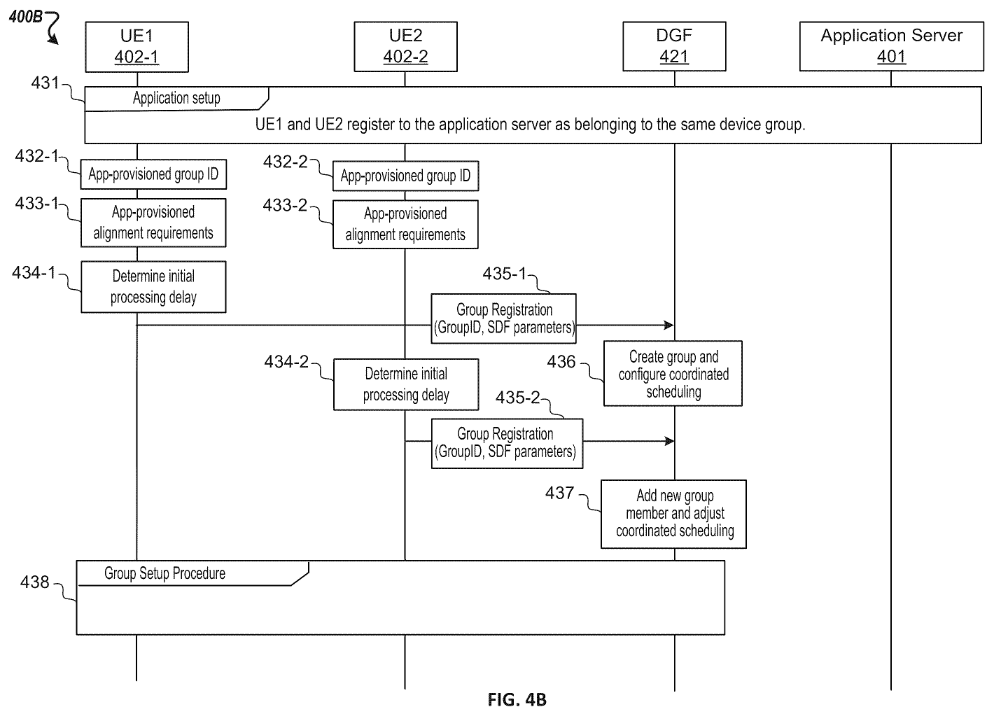

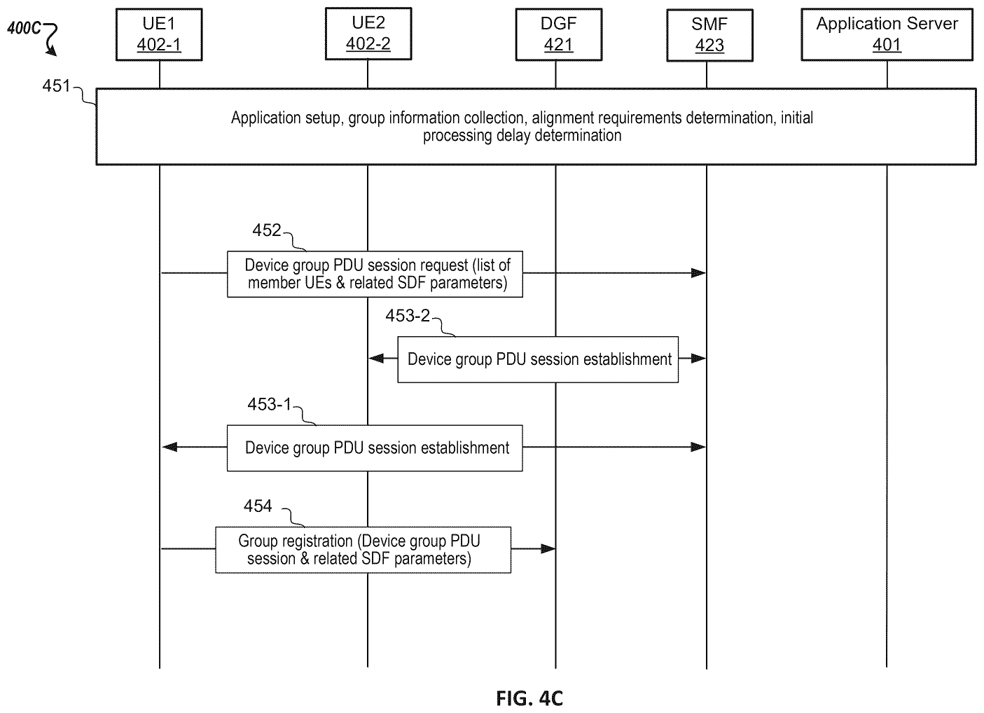

FIGS. 4A-4C each illustrate an example procedure of forming a device group including UEs 402-1 and 402-2, according to some implementations. Procedure 400A of FIG. 4A applies to scenarios where UE 402-1 serves as a management node that interacts with DGF 421 to register both UEs 402-1 and 402-2 in the device group, whereas procedure 400B of FIG. 4B applies to scenarios where UEs 402-1 and 402-2 each separately interacts with DGF 421 to register themselves in the device group without going through a management node. In addition, procedure 400C of FIG. 4C illustrates establishing a group PDU session for the device group. In FIGS. 4A-4C, UEs 402-1 and 402-2 can be similar to UE 102 of FIG. 1. DGF 421 can be implemented within a base station or within a CN. Also, application server 401 can be similar to application server 201 of FIG. 2A. The communications between UEs 402-1 and 402-2, DGF 421, and application server 401 can be via a RAN operated by a base station, which is omitted from the illustration.

In procedure 400A of FIG. 4A, at 411, UEs 402-1 and 402-2 register to application server 401 as belonging to the same device group. UEs 402-1 and 402-2 can register as devices performing an application managed by application server 401 and expect to communicate SDFs according to the application.

At 412, UE 402-1, which is the management node, collects information from UE 402-2 to prepare for group registration. As described above, the collected information can include, e.g., an ID of UE 402-2, processing capability of UE 402-2, inter-dependencies of SDFs that UE 402-2 expects to communicate, and other QoS parameters of UE 402-2. UE 402-1 can collect the information from an end-to-end (E2E) link with UE 402-2, such as a link established via UE 402-1, or local links directly established between the two UEs using, e.g., BLUETOOTH or WI-FI technologies.

At 413, UE 402-1 determines alignment requirements, such as timing constraints on inter-dependent SDFs and on inter-dependent UEs, as specified by the application. For example, application server 401 can provide UE 402-1 with QoS flow identifiers (QFIs) for the SDFs and/or one or more sets of filters to identify certain packets within the SDFs.

At 414, UE 402-1 determines an initial (e.g., before the forming of the device group) processing delay of UEs 402-1 and 402-2. For example, UE 402-1 can determine the processing delay of its own and obtains the processing delay of UE 402-2 based on the information obtained at 412.

At 415, UE 402-1, on behalf of itself and UE 402-2, transmits a device group registration request to DGF 421. In the device group registration request, UE 402-1 can provide a list of the IDs of UE 402-1 and UE 402-2 as group members. UE 402-1 can also provide DGF 421 with the parameters obtained in the operations at 412-414.

At 416, DGF 421 create a device group that includes UEs 402-1 and 402-2 in response to the device group registration request. DGF 421 can configure the RAN with coordinated scheduling based on the parameters received from UE 402-1 at 415.

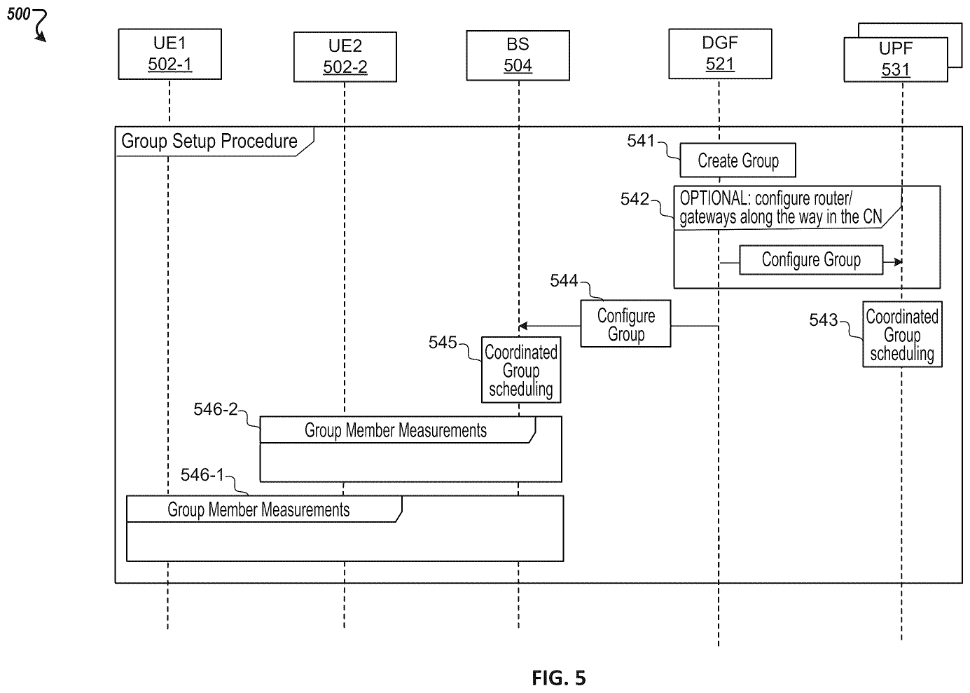

At 417, DGF informs UEs 402-1 and 402-2 of the setup of the device group and provides UEs 402-1 and 402-2 with group configurations. An example group setup procedure is described later with reference to FIG. 5.

In procedure 400B of FIG. 4B, operations at 431 are similar to those at 411 of procedure 400A, in which UEs 402-1 and 402-2 register to application server 401 as belonging to the same device group.

Because procedure 400B does not involve a management node, each of UEs 402-1 and 402-2 separately obtains information and transmits a request for forming a group. For example, at 432-1 and 432-2, UEs 402-1 and 402-2 respectively obtain a group ID from the application run by application server 401. With the group ID, UE 402-1 determines its alignment requirements, determines its initial processing delay, and sends a device group registration request to DGF 421. These operations, performed at 433-1, 434-1, and 435-1, can be similar to those performed by UE 402-1 at 413-415 of procedure 400A, except that the operations at 413-415 are performed on behalf of both of UEs 402-1 and 402-2 whereas the operations at 433-1, 434-1, and 435-1 of procedure 400B are performed by UE 402-1 on behalf itself. Likewise, at 433-2, 434-2, and 435-2, UE 402-2 determines its alignment requirements, determines its initial processing delay, and sends a device group registration request to DGF 421.

At 436, upon receiving the device group registration request from UE 402-1, DGF 421 creates a group and configures coordinated scheduling, similar to the operations at 416 of procedure 400A. Later when DGF 421 receives the device group registration request from UE 402-2, DGF 421 adds UE 402-2 to the group and makes adjustments to the coordinated scheduling at 437.

At 438, DGF 421 performs the group setup procedure similar to that performed at operation 417 of procedure 400A.

Once the SDF transmissions are scheduled by the DGF, the CN can configure the SDFs to be transmitted in one or more PDU sessions toward the device group. In some implementations, the CN configures multiple PDU sessions for transmitting the multiple SDFs, respectively, with each PDU session targeting a different receiving internet protocol (IP) address. With the configurations, the DGF can manage multiplexing of the SDFs in the PDU sessions towards the device group. In some alternative implementations, the CN configures a single group PDU session for all inter-dependent SDFs to be communicated with the same device group. The group PDU session can be mapped to multiple IP addresses, or mapped to a single address that directs to all the UEs addressed by the group PDU session, in which case the single address can be regarded by the application server as a virtual address. The procedure of setting up a group PDU session is described with reference to FIG. 4C in which UE 402-1 serves as a management node on behalf of UEs 402-1 and 402-2.

In procedure 400C of FIG. 4C, operations at 451 can be similar to those at 411-414 of procedure 400A. The description of operations at 451 is thus omitted for brevity.

At 452, UE 402-1 transmits a request to establish a group PDU session to the CN. The request, which is processed by a session management function (SMF) of the CN, can include the parameters obtained from both UEs 402-1 and 402-2 at 451.

At 453-1 and 453-2, the CN, via SMF 423, communicates with UEs 402-1 and 402-2 to establish the group PDU session for all inter-dependent SDFs addressed to UEs 402-1 and 402-2. UE1 402-1 can then inform DGF 421 about the group PDU session and the inter-dependencies of SDFs within the session.

At 454, UE 402-1 transmits a device group registration request to the CN, in particular to DGF 421. In addition to the information conveyed at 415 of procedure 400A, UE 402-1 at 454 can include parameters relating to the group PDU session, such as the group address of the PDU session.

The scenario illustrated in FIG. 4C involves a management node, UE 402-1, to transmit the request to establish the group PDU session. In alternative implementations, each of UEs 402-1 and 402-2 can interact with the CN separately to establish the group PDU session for the device group, without involving a management node. The operations in these alternative implementations can be similar to those with reference to FIG. 4C and are thus omitted for brevity.

FIG. 5 illustrates an example procedure 500 of device group setup, according to some implementations. Procedure 500 involves UEs 502-1 and 502-2 that form a device group by DGF 521, which can be implemented within base station (BS) 504 or a CN. Procedure 500 also involves one or more network functions of the CN, such as UPF 531. Some or all operations of procedure 500 can be implemented as the group setup operations at 417 and 438 of procedures 400A and 400B.

At 541, DGF 521 creates a group based on device group registration requests received from UEs 502-1 and/or 502-2. In procedures 400A and 400B where group creation is separate from group setup, operations at 521 can be omitted from the group setup procedure.

At 542, in scenarios where the CN involves routers and gateways, DGF 521 configures the routers and gateways and provide the CN, in particular UPF 531, with the device group information such that the CN is aware of the formation of the device group and provides network service accordingly.

At 543, UPF 531, possibly joined by DGF 521, generates information for coordinated group scheduling.

At 544 and 545, DGF 521, via BS 504, configures the device group with coordinated group scheduling.

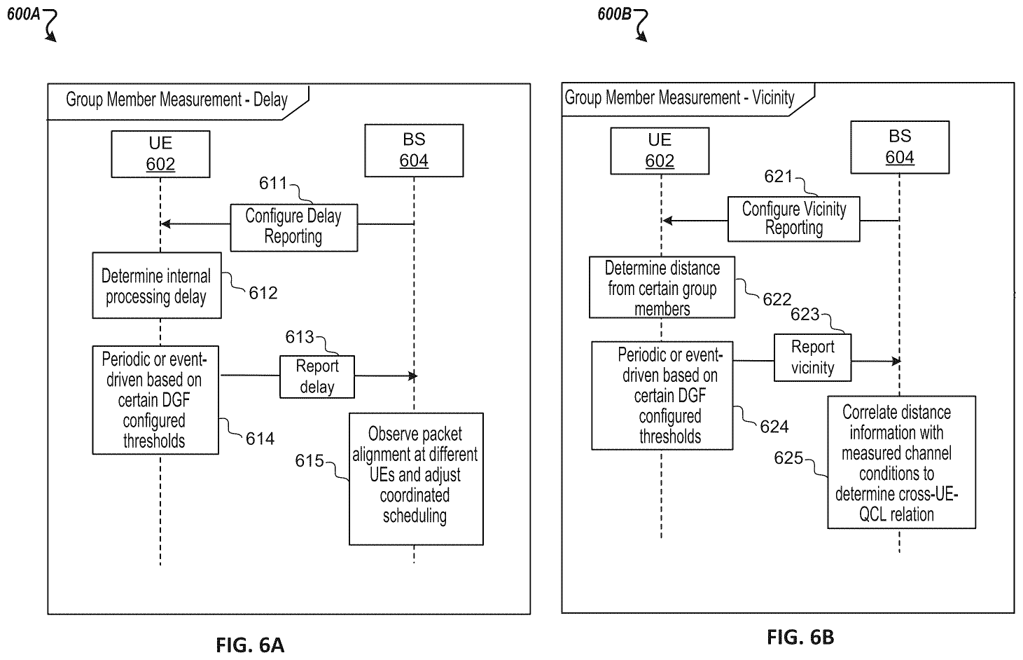

Based on the configuration, UEs 402-1 and 402-2 each perform group member measurement at 546-1 and 546-2, respectively. Two types of group member measurement are described below with reference to FIGS. 6A and 6B.

FIGS. 6A and 6B each illustrate an example procedure of group member measurement, according to some implementations. Procedure 600A of FIG. 6A illustrates measurement of the delay between group member UE 602 and BS 604, whereas procedure 600B of FIG. 6B illustrates measurement of the vicinity between UE 602 and BS 604.

At 611 of procedure 600A, BS 604 configures UE 602 to report delay measurement results. For example, BS 604 can configure UE 602 to report delay measurement results periodically or when triggered by an event.

At 612, UE 602 performs a measurement of its internal processing delay, which can indicate the processing capability of UE 602.

At 613 and 614, UE 602 determines to report the measured delay to BS 604. As described above, the reporting can occur periodically or upon being triggered by an event, which can be configured by a DGF via BS 604 at 611. In some implementations, the triggering event can include the change of one or more communications quality metrics across a threshold. For example, the DGF can configure UE 602 to report delay measurement results when the delay measured within the UE 602 exceeds a threshold, or when data in a buffer of UE 602 exceeds a threshold, when the number of discarded packets in an SDF exceeds a threshold, or when a reception power of UE 602 exceeds a threshold.

At 615, upon receiving the delay report from UE 602, BS 604 adjusts the coordinated scheduling based on the delay reports from UE 602 and other UEs in the device group. As such, the scheduling performed by BS 604 as managed by the DGF can be updated while continue to consider the alignment requirements.

At 621 of procedure 600B, BS 604 configures UE 602 to report vicinity measurement results (e.g., distance from another UE in the device group, from BS 604, or from another reference location). For example, BS 604 can configure UE 602 to report vicinity measurement results periodically or when triggered by an event.

At 622, UE 602 performs a vicinity measurement according to the configuration received at 621. The measurement result can indicate, e.g., the distance between UE 602 and another UE in the device group.

At 623 and 624, UE 602 determines to report the measured distance to BS 604. The reporting can occur periodically or upon being triggered by an event, which can be configured by a DGF via BS 604 at 621. For example, the triggering event can include the detection by a motion sensor that UE 602 moves in excess of a threshold distance, or the decrease of a communication quality between UE 602 and the other UE by a threshold value. The triggering event, as well as the thresholds involved, can be configured by a DGF via BS 604.

At 625, BS 604, based on the vicinity measurement result received from UE 602, correlates the distance information with measured channel conditions, which can be indicated by metrics such as reference signal received power (RSRP) and reference signal strength indicator (RSSI). BS 604 can determine QCL relations between UE 602 and the other UE and make coordinated scheduling accordingly.

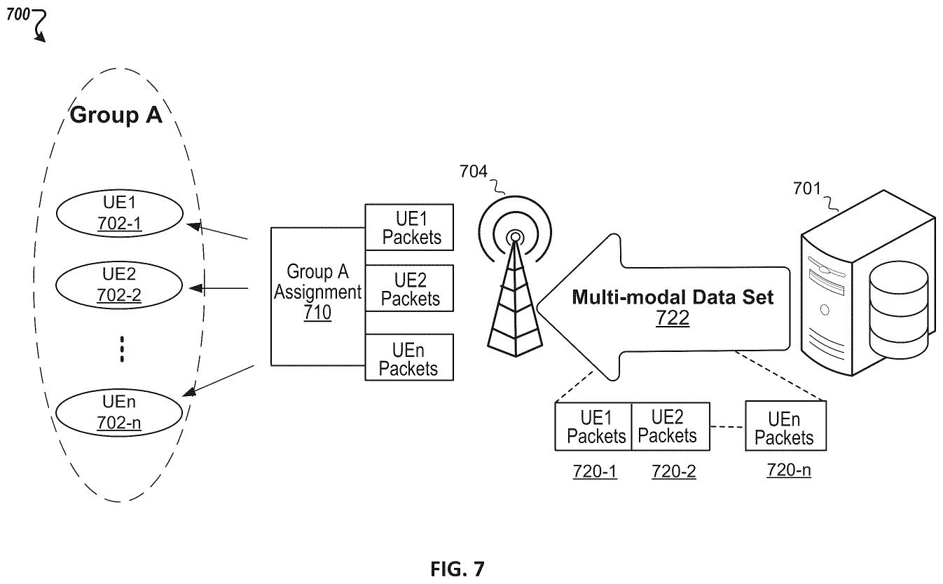

FIG. 7 illustrates an example wireless network 700 with a group of UEs 702-1 to 702-n (collectively referred to as UEs 702), according to some implementations. UEs 702, which all belong to device group A, receive multi-modal data set 722, which is provided by application server 701 via base station 704. Data set 722 can be structured in a message with packets 720-1, 720-2, . . . 720-n (collectively referred to as packets 720) that respectively provide radio resource assignment parameters to UEs 702. An example application of the architecture of network 700 is XR application where a user controls UEs 702 to perform an XR task with application server 701.

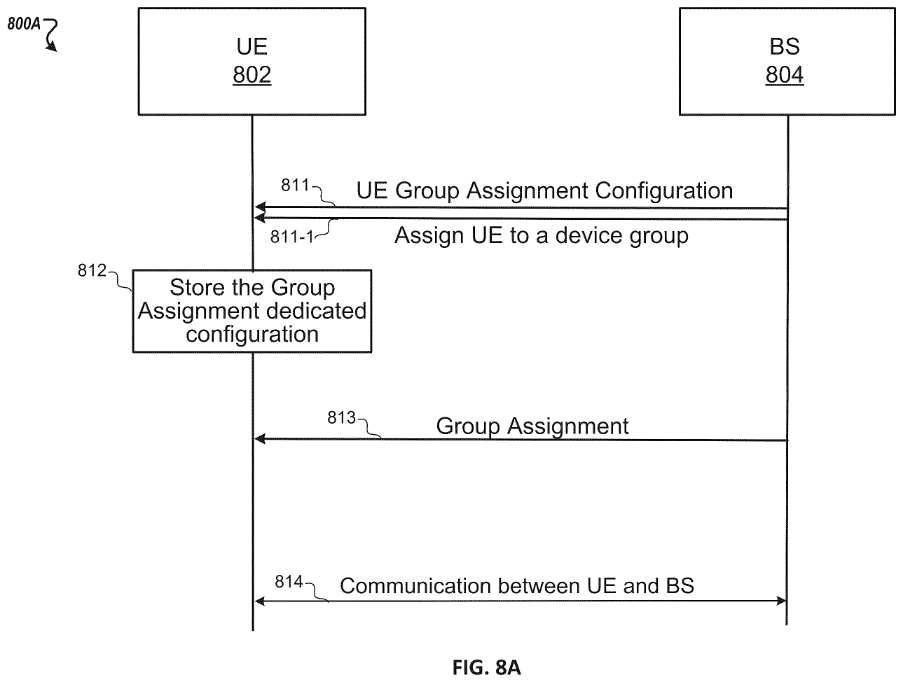

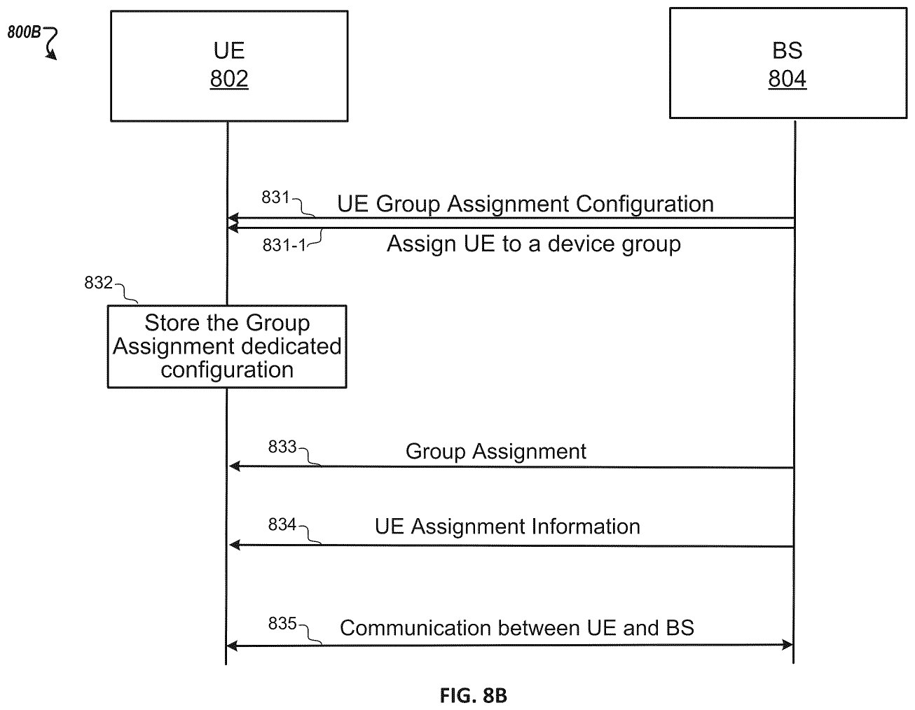

Each of UEs 702 in device group A can be configured with group assignment configuration information (e.g., one or more group assignment configuration sets) to be used when exchanging data payloads with application server 701. The group assignment configuration information can indicate a dedicated radio resources assignment parameters, such as a set of physical resource blocks (PRBs), for each of UEs 702 to communicate with application server 701 via base station 704. The provision of the group assignment configuration information can be performed in a semi-static manner or a dynamic manner, which are described later with reference to FIGS. 8A and 8B.

After assigning UEs 702 to group A, base station 704 transmits the data included in packets 720 to each of UEs 702 via a single group assignment message 710, which can be identified by a group ID such as radio network temporary identifier (RNTI). By monitoring for and receiving group assignment message 710 from base station 704, each of UEs 702 can determine the radio resources assignment parameters based on the group assignment configuration and the parameters received in group assignment message 710. Using the determined radio resource assignment parameter, each of UEs 702 can determine radio resources when starting to exchange data payloads with base station 704.

FIGS. 8A and 8B each illustrate an example procedure of group assignment, 800A and 800B, respectively, according to some implementations. Procedures 800A and 800B are performed between BS 804, which can be similar to base station 704 of FIG. 7, and UE 802, which can be similar to any of UEs 702 of FIG. 7. Procedure 800A illustrates a semi-static approach of configuring UE 802 with assignment information, whereas procedure 800B illustrates a dynamic approach of configuring UE 802 with assignment information.

In procedure 800A of FIG. 8A, at 811, BS 804 transmits group assignment configuration information to UE 802, providing UE 802 with one or more radio resource assignment parameters, which can be organized in a dedicated resource set. In addition to indicating the dedicated resource set for UE 802, the group assignment configuration information can include, e.g., modulation schemes, channel coding schemes, and start offsets and sizes of radio resource in frequency and time domains, to be used by UE 802 when communicating with BS 804. The group assignment configuration information can be transmitted to UE 802 via, e.g., secured radio resource control (RRC) signaling. When UE 802 belongs to a device group (e.g. group A of FIG. 7), BS 804 can similarly transmit dedicated group assignment configuration information to other UEs in the device group. The group assignment configuration information received by each UE in a group can include parameters that are UE-specific possibly accompanied by parameters that are common to all UEs in the device group.

In some implementations, the group assignment configuration information is transmitted along with or as part of the coordinated group scheduling signaling, which has been described with reference to FIGS. 4A-5, via which a DGF assigns multiple UEs in a device group. For example, messages with group assignment configuration information dedicated to UEs 402 can be transmitted from DGF 421 via a base station respectively to UEs 402 in FIGS. 4A-4C during or after the group setup operations at 417 or 438.

At 811-1, BS 804 transmits a grouping message to UE 802 to assign UE 802 to a device group having one or more other UEs. In some implementations, the grouping message is transmitted via, e.g., an RRC message, a layer 2 (L2) medium access control (MAC) control element (CE), or a layer 1 (L1) message. In some implementations, the grouping message is transmitted as part of the group assignment configuration information at 811. In these implementations, operations at 811 and 811-1 can be combined. When the grouping message is transmitted separate from the group assignment configuration information, the grouping message can be transmitted at a time independent to the time of transmitting the group assignment configuration information.

At 812, UE 802 stores the dedicated assignment configuration information into its memory. Based on the stored information, UE 802 can monitor for a group assignment message, which can serve as a communication grant that triggers UE 802 to communicate data with BS 804.

At 813, BS 804 transmits the group assignment message to UE 802, e.g., via downlink control information (DCI) signaling over a physical downlink control channel (PDCCH). When UE 802 belong to a device group with multiple UEs, BS 804 can transmit a single group assignment message to all UEs in the device group, such as the transmission of group assignment message 710 to UEs 702 in FIG. 7. The group assignment message, which can serve as a single communication grant for all UEs in the device group. All UEs in the device group, including UE 802 and other UEs, can start communicating with BS 804 upon receipt of the group assignment message. Compared to other approaches where each UE is individually granted communication by a dedicated message, the approach described herein simplifies the communication procedure and reduces the communication overhead by allowing transmission of a single group assignment message.

The group assignment message transmitted at 813 can include one or more radio resource assignment parameters that are common for UE 802 and the other UEs in the device group. These radio resource assignment parameters in the group assignment message can supplement those in the dedicated resource set. Alternatively or additionally, some radio resource assignment parameters in the group assignment message can overlap those in the dedicated resource set received at 811, and it is up to UE 802 to decide whether to use the radio resource assignment parameters received at 811 or overwrite those with the radio resource assignment parameters in the group assignment message. UE 802 can make the decision on its own or based on a configuration by BS 804.

The group assignment message, which is common to all UEs in a device group, can provide information that can be used by each UE to derive UE-specific radio resource assignment parameters. As an example, in the group assignment message transmitted at 813, BS 804 can provide to UE 802 and other UEs in the device group a starting offset of radio resource PRBs is 5 and a number of allocated PRBs is 10. Based on this information and each UE's index in the group, that BS 804 assigns to UE 802 in 811-1, each UE can derive which resources to use when communicating with BS 804: The UE with an index of I uses resources starting from PRB #5, the UE with an index of 2 uses resources starting from PRB #15, the UE with an index of 3 uses resources starting from PRB #25, and so forth.

At 814, upon receiving the group assignment message and determining the radio resource assignment parameters, UE 802 communicates with BS 804 to exchange data payloads. For example, UE 802 can transmit pending data in its buffer to BS 804 according to at least one of the parameters in the dedicated group assignment configuration information or the parameters in the group assignment message. Similarly, other UEs in the same device group can, upon receiving the group assignment message and determining the radio resource assignment parameters, respectively transmit their pending data to BS 804 or receive data from BS 804. In the event when UE 802 does not have pending data to transmit, UE 802 can skip the transmission.

In procedure 800B of FIG. 8B, operations at 831, 831-1, and 832 are similar to those at 811, 811-1, and 812 of procedure 800A, in which UE 802 receives and stores dedicated assignment configuration information from BS 804.

At 833, UE 802 receives a group assignment message from BS 804. Different from the group assignment message received at 813 of procedure 800A, the group assignment message received at 833 does not directly provide the radio resource assignment parameters. Instead, the group assignment message received at 833 triggers UE 802 to monitor for and receive a message with UE assignment information at 834, with the UE assignment information message providing the radio resource assignment parameters dedicated to UE 802. The UE assignment information message can dynamically grant UE 802 to communicate with BS 804 using the radio resource assignment parameters provided using a resource (e.g., slot and PRB) according to a rule given in the dedicated assignment configuration information. For example, the dedicated assignment configuration information can specify that, if the group assignment message is received in slot N, then UE with an index of X can receive its UE assignment information message at the X-th PRB of slot N. As another example, the dedicated assignment configuration information can specify that if the group assignment message is received in slot N, then UE with an index of X can receive its UE assignment information message at the (X+K)-th PRB of slot N, where K is a offset (e.g., 9) whose value can be a predefined constant or can be communicated by BS 804. As another example, the dedicated assignment configuration information can specify that if the group assignment message is received in slot N, then UE with an index of X can receive its UE assignment information message at the (X+K×M)-th PRB of slot N, where K is a offset whose value can be a predefined constant or can be communicated by BS 804 and M is the ID of the group to which the UE belongs.

After obtaining radio resource assignment parameters from the UE assignment information message, UE 802 communicates data with BS 804 at 835. The operations at 835 can be similar to those at 814 of procedure 800A.

In some implementations according to procedures 800A or 800B, the radio resource assignment parameters include one or more parameters that are common to all UEs in the device group and one or more parameters that are specific to UE 802. In an example of XR multi-user gaming applications where a gaming server is wirelessly connected to multiple identical XR glasses that have the same characteristics (e.g., capabilities or channel conditions) in a network, the network can group the multiple glasses to receive multi-modal data from the gaming server based on the same radio resource assignment parameters. If, in the same multi-user gaming applications, the gaming server is also wirelessly connected to multiple different XR devices that have the different characteristics, the network can still group the multiple devices to receive multi-modal data from the gaming server but the radio resource assignment parameters may be different between the devices. The gaming server can possibly provide a subset of radio resource assignment parameters that are common (e.g., independent to the device's characteristics) to all devices while providing another subset of radio resource assignment parameters that are specific (dependent on the device's characteristics) to each device.

In some implementations, by providing the radio resource assignment parameters, BS 804 can overwrite and/or override one or more configurations that UE 802 receives from the dedicated group assignment configuration information at 811 of procedure 800A or at 831 of procedure 800B. For example, BS 804 can specify, in the dedicated group assignment configuration information, one or more resources for UE 802 to use when communicating at 814 or 835, but later at 813 or 834 specify one or more different resources when providing the radio resource assignment parameters. UE 802 can be configured to determine whether to adopt the later-provided resources or the earlier-configured resources. If adopting the later-provided resources in the radio resource assignment parameters, UE 802 can further store the actually used resources in its memory to overwrite the existing resources stored at 812 or 832.

For multiple UEs in a device group, each UE can determine whether to use the semi-static approach or the dynamic approach to receive the radio resource assignment parameters. Alternatively or additionally, each UE can determine whether to overwrite or override its dedicated assignment configuration information with the later-received radio resource assignment parameters. Each UE can make its determination independent from other UEs' choices.

In some implementations, UEs are flexibly and dynamically added to a device group, removed from a device group, or switched from one device group to another device group, either at the UEs' request or pursuant to a decision of the network (e.g., upon receiving an instruction from the base station). For example, a UE can request to be added to a device group by indicating that the UE has a relationship with the devices in the device group (e.g., the UE and those in the device group are configured for the same XR application). Alternatively or additionally, multiple UEs can request to be added to the same device group if the UEs all have pending data on respective radio bearers with the same QoS requirements.

In some implementations, a UE can be assigned to multiple device groups and receive dedicated assignment configuration information for these groups. The base station can, via a L1, L2, or L3 command, indicate to the UE whether a device group the UE belongs to is active (e.g., whether radio resource assignment parameters are to be provided for that group) and configure the UE to selectively apply dedicated assignment configuration information of the active group(s). The base station can further divide a device group into multiple subgroups and assign the UEs in the same device group to different subgroups. The base station can manage a device group by dynamically adding or removing UEs to or from a device group. The UEs can be added in more than one device group.

In some implementations, a UE can receive multiple dedicated group assignment configuration information sets. The UE can select, based on the base station configuration associated with the device group received in 811-1, the dedicated group assignment configuration information set to use in the communication.

In some implementations, after receiving the radio resource assignment parameters, a UE skips data transmission if there is no pending data in the buffer of the UE. Alternatively or additionally, the UE does not transmit data unless the last buffer status report (BSR) transmitted to the network has a non-zero value.

In some implementations, a UE receiving a group assignment message granting communication in a slot can be individually granted communication in the same slot by a message dedicated to the UE (e.g., a grant addressed to the UE only). To avoid a conflict, the UE can be configured to communicate in accordance with one of the two grants. For example, the UE can be configured to follow the dedicated grant message while ignoring the group assignment message.

In some implementations, the base station's signaling of the group assignment message can be accompanied by transmitting a hybrid automatic repeat request (HARQ) message to the UE. Alternatively or additionally, the signaling of the group assignment message can be accompanied by configured grant signaling.

In some implementations, a UE can indicate to the base station whether the UE supports the features described above. For example, the UE can indicate whether the UE supports coordinated scheduling as part of a device group, and whether the UE supports the semi-static group assignment procedures described in FIGS. 8A and 8B. The indications can be sent to the base station via, e.g., RRC signaling, such as an RRC Capability Response message.

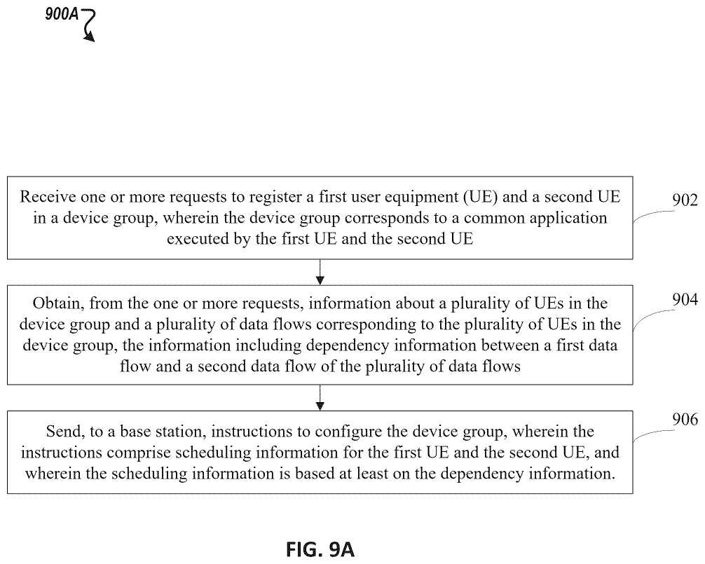

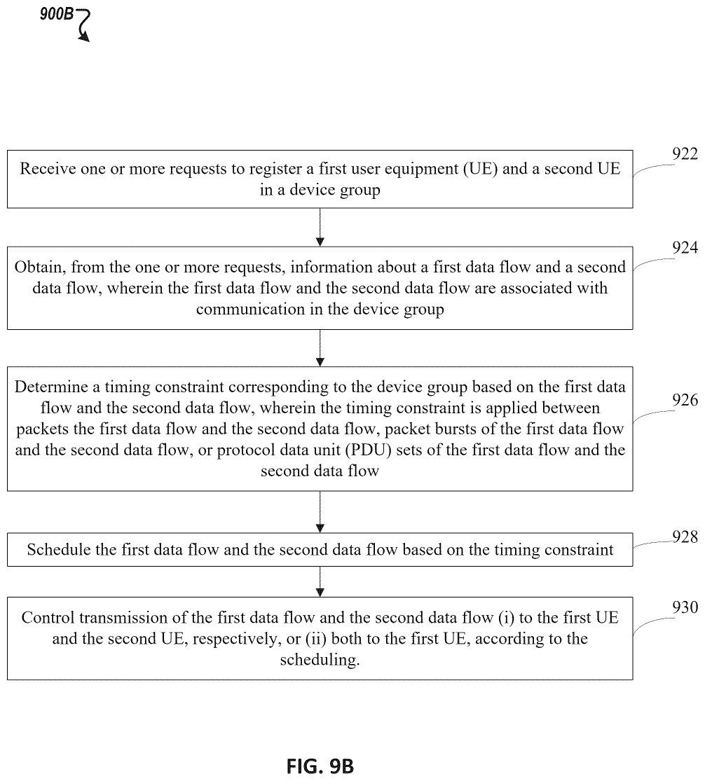

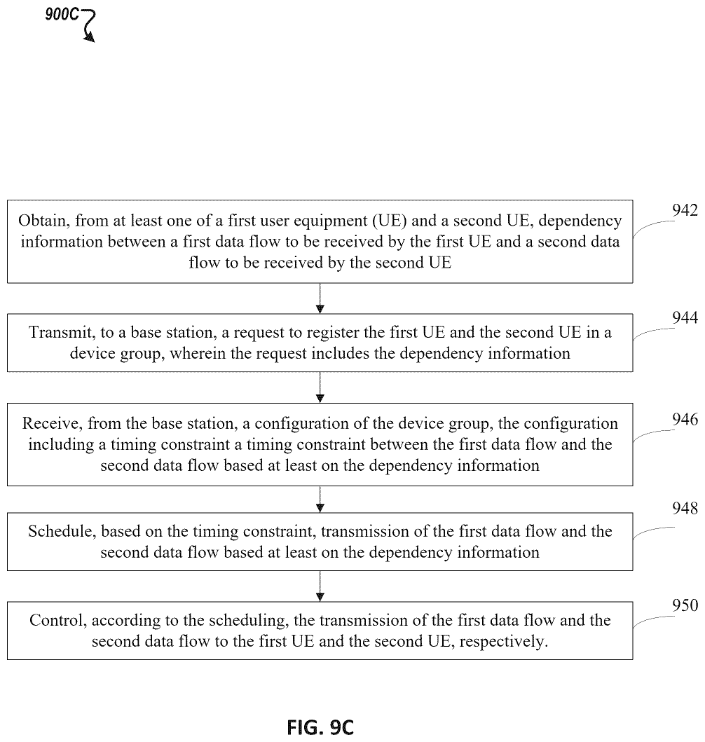

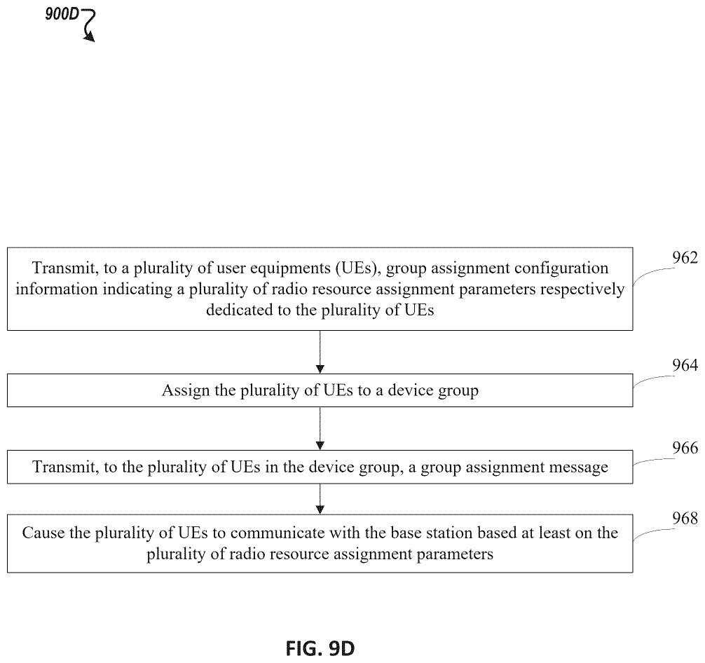

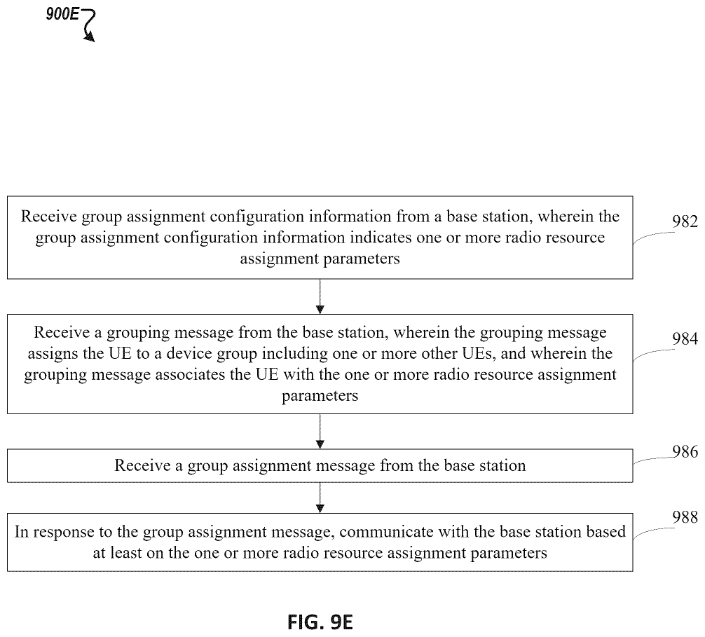

FIGS. 9A-9E illustrate flowcharts of example methods 900A-900E, respectively, for device group communication, according to some implementations. For clarity of presentation, the description that follows generally describes methods 900A-900E in the context of the other figures in this description. For example, method 900A can be performed by a DGF implemented within CN 205 of FIG. 2A or 2B; method 900B can be performed by a DGF implemented within base station 204 of FIG. 2A, 2B, or 2E, or a DGF implemented within UE 203 of FIG. 2C or 2D; method 900C can be performed by UE 203 serving as a management node in FIG. 2A or 2D; method 900D can be performed by BS 804 of FIG. 8A or 8B; and method 900E can be performed by UE 802 of FIG. 8A or 8B. It will be understood that methods 900A-900E can be performed, for example, by any suitable system, environment, software, hardware, or a combination of systems, environments, software, and hardware, as appropriate. In some implementations, various steps of methods 900A-900E can be run in parallel, in combination, in loops, or in any order.

In FIG. 9A, at 902, method 900A involves receiving one or more requests to register a first UE and a second UE in a device group. The one or more requests can be similar to the requests transmitted at 415, 435-1, or 435-2 of FIGS. 4A and 4B. The device group corresponds to a common application, such as an XR application, executed by the first UE and the second UE.

At 904, method 900A involves obtaining, from the one or more requests, information about a plurality of UEs in the device group and a plurality of data flows corresponding to the plurality of UEs. The information includes dependency information between a first data flow and a second data flow of the plurality of data flows. The first and second data flows can be communicated with the same UE or two different UEs.

At 906, method 900A involves sending, to a base station, instructions to configure the device group, the instructions including scheduling information for the first UE and the second UE. The scheduling information can be based on the dependency information. The instructions can be sent in the group setup procedure of FIG. 5.

In FIG. 9B, at 922, method 900B involves receiving one or more requests to register a first user equipment (UE) and a second UE in a device group. The one or more requests can be similar to the requests transmitted at 415, 435-1, or 435-2 of FIGS. 4A and 4B.

At 924, method 900B involves obtaining, from the one or more requests, information about a first data flow and a second data flow. The first data flow and the second data flow are associated with communication in the device group, such as communication of video or audio data with a group of XR devices.

At 926, method 900B involves determining a timing constraint corresponding to the device group based on the first data flow and the second data flow. The timing constraint can include an MPBD, such as the MPBD illustrated in FIG. 3. The timing constraint is applied between packets the first data flow and the second data flow, packet bursts of the first data flow and the second data flow, or PDU sets of the first data flow and the second data flow.

At 928, method 900B involves scheduling the first data flow and the second data flow based on the timing constraint. The scheduling can be similar to the operations of FIG. 3.

At 930, method 900B involves controlling transmission of the first data flow and the second data flow (i) to the first UE and the second UE, respectively, or (ii) both to the first UE, according to the scheduling.

In FIG. 9C, at 942, method 900C involves obtaining, from at least one of a first UE and a second UE, dependency information between a first data flow to be received by the first UE and a second data flow to be received by the second UE.

At 944, method 900C involves transmitting, to a base station, a request to register the first UE and the second UE in a device group. The request includes the dependency information.

At 946, method 900C involves receiving, from the base station, a configuration of the device group. The configuration includes a timing constraint between the first data flow and the second data flow based at least on the dependency information.

At 948, method 900C involves scheduling, based on the timing constraint, transmission of the first data flow and the second data flow. The scheduling can be similar to the operations of FIG. 3.

At 950, method 900C involves controlling, according to the scheduling, the transmission of the first data flow and the second data flow to the first UE and the second UE, respectively.

In FIG. 9D, at 962, method 900D involves transmitting, to a plurality of UEs, group assignment configuration information indicating a plurality of radio resource assignment parameters respectively dedicated to the plurality of UEs. The transmission of the group assignment configuration information can be similar to the operations at 811 or 831 in FIGS. 8A and 8B.

At 964, method 900D involves assigning the plurality of UEs to a device group. The operations at 964 can be similar to the operations at 811-1 or 831-1 in FIGS. 8A and 8B.

At 966, method 900D involves transmitting, to the plurality of UEs in the device group, a group assignment message. The group assignment message can include one or more radio resource assignment parameters that are common to all UEs in the group. In dynamic scheduling such as procedure 800B, the group assignment message can be accompanied or followed by UE assignment information that provides each UE with dedicated radio resource assignment parameters.

At 968, method 900D involves causing the plurality of UEs to communicate with the base station based at least on the plurality of radio resource assignment parameters. Each UE can determine whether to overwrite or override the radio resource assignment parameters indicated in the group assignment configuration information with radio resource assignment parameters indicated in the group assignment message and, in case of dynamic scheduling, indicated in the UE assignment information. The communication can be similar to the operations at 814 or 835 in FIG. 8A or 8B.

In FIG. 9E, at 982, method 900E involves receiving group assignment configuration information from a base station. The group assignment configuration information indicates one or more radio resource assignment parameters dedicated to the UE. The reception of the group assignment configuration information can be similar to the operations at 811 or 831 in FIGS. 8A and 8B.

At 984, method 900E involves receiving a grouping message from the base station. The grouping message assigns the UE to a device group including one or more other UEs, and associates the UE with the one or more radio resource assignment parameters. The reception of the group message can be similar to the operations at 811-1 or 831-1 in FIGS. 8A and 8B.

At 986, method 900E involves receiving a group assignment message from the base station. The group assignment message can include one or more radio resource assignment parameters that are common to all UEs in the device group. In dynamic scheduling such as procedure 800B, the group assignment message can be accompanied or followed by UE assignment information that provides the UE with dedicated radio resource assignment parameters.

At 988, method 900E involves, in response to the group assignment message, communicating with the base station based at least on the one or more radio resource assignment parameters. The communication can be similar to the operations at 814 or 835 in FIG. 8A or 8B.

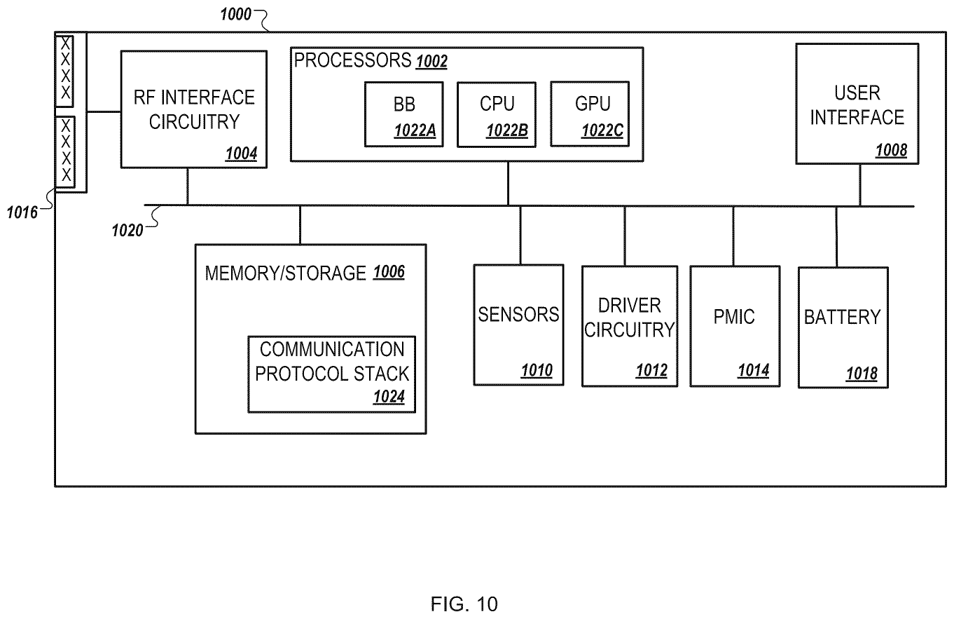

FIG. 10 illustrates an example UE 1000, according to some implementations. The UE 1000 may be similar to and substantially interchangeable with UE 102 of FIG. 1.

The UE 1000 may be any mobile or non-mobile computing device, such as, for example, mobile phones, computers, tablets, industrial wireless sensors (for example, microphones, pressure sensors, thermometers, motion sensors, accelerometers, inventory sensors, electric voltage/current meters, etc.), video devices (for example, cameras, video cameras, etc.), wearable devices (for example, a smart watch), relaxed-IoT devices.

The UE 1000 may include processors 1002, RF interface circuitry 1004, memory/storage 1006, user interface 1008, sensors 1010, driver circuitry 1012, power management integrated circuit (PMIC) 1014, one or more antenna(s) 1016, and battery 1018. The components of the UE 1000 may be implemented as integrated circuits (ICs), portions thereof, discrete electronic devices, or other modules, logic, hardware, software, firmware, or a combination thereof. The block diagram of FIG. 10 is intended to show a high-level view of some of the components of the UE 1000. However, some of the components shown may be omitted, additional components may be present, and different arrangement of the components shown may occur in other implementations.

The components of the UE 1000 may be coupled with various other components over one or more interconnects 1020, which may represent any type of interface, input/output, bus (local, system, or expansion), transmission line, trace, optical connection, etc. that allows various circuit components (on common or different chips or chipsets) to interact with one another.

The processors 1002 may include processor circuitry such as, for example, baseband processor circuitry (BB) 1022A, central processor unit circuitry (CPU) 1022B, and graphics processor unit circuitry (GPU) 1022C. The processors 1002 may include any type of circuitry or processor circuitry that executes or otherwise operates computer-executable instructions, such as program code, software modules, or functional processes from memory/storage 1006 to cause the UE 1000 to perform operations as described herein.

In some implementations, the baseband processor circuitry 1022A may access a communication protocol stack 1024 in the memory/storage 1006 to communicate over a 3GPP compatible network. In general, the baseband processor circuitry 1022A may access the communication protocol stack to: perform user plane functions at a physical (PHY) layer, medium access control (MAC) layer, radio link control (RLC) layer, packet data convergence protocol (PDCP) layer, service data adaptation protocol (SDAP) layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 1004. The baseband processor circuitry 1022A may generate or process baseband signals or waveforms that carry information in 3GPP-compatible networks. In some implementations, the waveforms for NR may be based cyclic prefix orthogonal frequency division multiplexing (OFDM) “CP-OFDM” in the uplink or downlink, and discrete Fourier transform spread OFDM “DFT-S-OFDM” in the uplink.

The memory/storage 1006 may include one or more non-transitory, computer-readable media that includes instructions (for example, communication protocol stack 1024) that may be executed by one or more of the processors 1002 to cause the UE 1000 to perform various operations described herein. The memory/storage 1006 include any type of volatile or non-volatile memory that may be distributed throughout the UE 1000. In some implementations, some of the memory/storage 1006 may be located on the processors 1002 themselves (for example, L1 and L2 cache), while other memory/storage 1006 is external to the processors 1002 but accessible thereto via a memory interface. The memory/storage 1006 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1004 may include transceiver circuitry and radio frequency front module (RFEM) that allows the UE 1000 to communicate with other devices over a radio access network. The RF interface circuitry 1004 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna(s) 1016 and proceed to filter and amplify (with a low-noise amplifier) the signal. The signal may be provided to a receiver of the transceiver that downconverts the RF signal into a baseband signal that is provided to the baseband processor of the processors 1002.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna(s) 1016. In various implementations, the RF interface circuitry 1004 may be configured to transmit/receive signals in a manner compatible with NR access technologies.

The antenna(s) 1016 may include one or more antenna elements to convert electrical signals into radio waves to travel through the air and to convert received radio waves into electrical signals. The antenna elements may be arranged into one or more antenna panels. The antenna(s) 1016 may have antenna panels that are omnidirectional, directional, or a combination thereof to enable beamforming and multiple input, multiple output communications. The antenna(s) 1016 may include microstrip antennas, printed antennas fabricated on the surface of one or more printed circuit boards, patch antennas, phased array antennas, etc. The antenna(s) 1016 may have one or more panels designed for specific frequency bands including bands in FR1 or FR2.

The user interface 1008 includes various input/output (I/O) devices designed to enable user interaction with the UE 1000. The user interface 1008 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 1000.

The sensors 1010 may include devices, modules, or subsystems whose purpose is to detect events or changes in its environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; temperature sensors (for example, thermistors); pressure sensors; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 1012 may include software and hardware elements that operate to control particular devices that are embedded in the UE 1000, attached to the UE 1000, or otherwise communicatively coupled with the UE 1000. The driver circuitry 1012 may include individual drivers allowing other components to interact with or control various input/output (I/O) devices that may be present within, or connected to, the UE 1000. For example, driver circuitry 1012 may include a display driver to control and allow access to a display device, a touchscreen driver to control and allow access to a touchscreen interface, sensor drivers to obtain sensor readings of sensors 1010 and control and allow access to sensors 1010, drivers to obtain actuator positions of electro-mechanic components or control and allow access to the electro-mechanic components, a camera driver to control and allow access to an embedded image capture device, audio drivers to control and allow access to one or more audio devices.

The PMIC 1014 may manage power provided to various components of the UE 1000. In particular, with respect to the processors 1002, the PMIC 1014 may control power-source selection, voltage scaling, battery charging, or DC-to-DC conversion.

In some implementations, the PMIC 1014 may control, or otherwise be part of, various power saving mechanisms of the UE 1000. A battery 1018 may power the UE 1000, although in some examples the UE 1000 may be mounted deployed in a fixed location, and may have a power supply coupled to an electrical grid. The battery 1018 may be a lithium ion battery, a metal-air battery, such as a zinc-air battery, an aluminum-air battery, a lithium-air battery, and the like. In some implementations, such as in vehicle-based applications, the battery 1018 may be a typical lead-acid automotive battery.

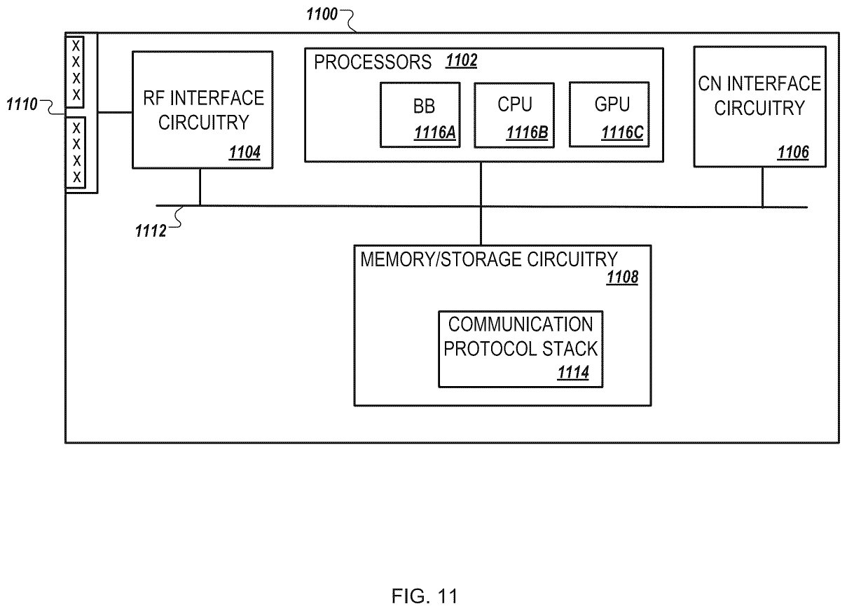

FIG. 11 illustrates an example access node 1100 (e.g., a base station or gNB), according to some implementations. The access node 1100 may be similar to and substantially interchangeable with base station 104. The access node 1100 may include processors 1102, RF interface circuitry 1104, core network (CN) interface circuitry 1106, memory/storage circuitry 1108, and one or more antenna(s) 1110.

The components of the access node 1100 may be coupled with various other components over one or more interconnects 1112. The processors 1102, RF interface circuitry 1104, memory/storage circuitry 1108 (including communication protocol stack 1114), antenna(s) 1110, and interconnects 1112 may be similar to like-named elements shown and described with respect to FIG. 10. For example, the processors 1102 may include processor circuitry such as, for example, baseband processor circuitry (BB) 1116A, central processor unit circuitry (CPU) 1116B, and graphics processor unit circuitry (GPU) 1116C.

The CN interface circuitry 1106 may provide connectivity to a core network, for example, a 5th Generation Core network (5GC) using a 5GC-compatible network interface protocol such as carrier Ethernet protocols, or a CN under 6G or some other suitable protocol. Network connectivity may be provided to/from the access node 1100 via a fiber optic or wireless backhaul. The CN interface circuitry 1106 may include one or more dedicated processors or FPGAs to communicate using one or more of the aforementioned protocols. In some implementations, the CN interface circuitry 1106 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1100 that operates in an NR or 5G system (for example, a gNB), and the term “E-UTRAN node” or the like may refer to an access node 1100 that operates in an LTE or 4G system (e.g., an eNB). According to various implementations, the access node 1100 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1100 may be implemented as one or more software entities running on server computers as part of a virtual network, which may be referred to as a CRAN and/or a virtual baseband unit pool (vBBUP). In V2X scenarios, the access node 1100 may be or act as a “Road Side Unit.” The term “Road Side Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary implementations are provided.

Example 1 includes a method including: receiving one or more requests to register a first user equipment (UE) and a second UE in a device group, wherein the device group corresponds to a common application executed by the first UE and the second UE; obtaining, from the one or more requests, information about a plurality of UEs in the device group and a plurality of data flows corresponding to the plurality of UEs in the device group, the information including dependency information between a first data flow and a second data flow of the plurality of data flows; and sending, to a base station, instructions to configure the device group, wherein the instructions include scheduling information for the first UE and the second UE, and wherein the scheduling information is based at least on the dependency information.

Example 2 includes the method of example 1, wherein the first data flow and the second data flow both correspond to the first UE.

Example 3 includes the method of example 1, wherein the first data flow and the second data flow correspond to the first UE and the second UE, respectively.

Example 4 includes the method of example 3, wherein sending the instructions to configure the device group includes determining, based on the dependency information between the first data flow and the second data flow, a timing constraint between the first data flow and the second data flow, and wherein the scheduling information for the first UE and the second UE is based at least on the timing constraint.

Example 5 includes the method of example 4, wherein determining the timing constraint is based on determining a processing capability of at least one of the first UE or the second UE.

Example 6 includes the method of example 4, further including: instructing the base station to transmit the first data flow and the second data flow to the first UE and the second UE, respectively, according to the timing constraint.

Example 7 includes the method of example 4, wherein the timing constraint includes a time window characterized by a maximum time difference between a first time at which the first UE receives data corresponding to the first data flow and a second time at which the second UE receives data corresponding to the second data flow during a specified time period.

Example 8 includes the method of example 4, further including determining the scheduling information based on at least one of: delay measurement results reported by the first UE and the second UE, vicinity measurement results reported by the first UE and the second UE, or quasi-colocation (QCL) information between the first UE and the second UE.

Example 9 includes the method of example 4, wherein the instructions further include at least one of: an identifier of the device group, priority information of the plurality of data flows, one or more policies for scheduling failure, or one or more UE reporting configurations.

Example 10 includes the method of example 1, further including: instructing a session management function (SMF) to establish a plurality of PDU sessions with the device group, wherein the plurality of PDU sessions include a first PDU session corresponding to the first data flow and a second PDU session corresponding to the second data flow.

Example 11 includes the method of example 1, further including: receiving, from the plurality of UEs, a request to establish a group protocol data unit (PDU) session; and instructing the a session management function (SMF) to establish the group PDU session with the device group, wherein the group PDU session includes one or more member PDU sessions.

Example 12 includes the method of example 11, wherein the first data flow and the second data flow are transmitted in a same member PDU session of the one or more PDU sessions.

Example 13 includes a method including: receiving one or more requests to register a first user equipment (UE) and a second UE in a device group; obtaining, from the one or more requests, information about a first data flow and a second data flow, wherein the first data flow and the second data flow are associated with communication in the device group; determining a timing constraint corresponding to the device group based on the first data flow and the second data flow, wherein the timing constraint is applied between packets the first data flow and the second data flow, packet bursts of the first data flow and the second data flow, or protocol data unit (PDU) sets of the first data flow and the second data flow; scheduling the first data flow and the second data flow based on the timing constraint; and controlling transmission of the first data flow and the second data flow (i) to the first UE and the second UE, respectively, or (ii) both to the first UE, according to the scheduling.

Example 14 includes the method of example 13, wherein the information about the first data flow and the second data flow includes dependency information between the first data flow and the second data flow.

Example 15 includes the method of example 14, wherein the first data flow and the second data flow correspond to the first UE and the second UE, respectively, and wherein determining the timing constraint includes: determining, based on the dependency information, a time window characterized by a maximum time difference between a first time at which the first UE receives data corresponding to the first data flow and a second time at which the second UE receives data corresponding to the second data flow during a specified time period.

Example 16 includes a method including: obtaining, from at least one of a first user equipment (UE) and a second UE, dependency information between a first data flow to be received by the first UE and a second data flow to be received by the second UE; transmitting, to a base station, a request to register the first UE and the second UE in a device group, wherein the request includes the dependency information; receiving, from the base station, a configuration of the device group, the configuration including a timing constraint between the first data flow and the second data flow based at least on the dependency information; scheduling, based on the timing constraint, transmission of the first data flow and the second data flow; and controlling, according to the scheduling, the transmission of the first data flow and the second data flow to the first UE and the second UE, respectively.

Example 17 includes the method of example 16, wherein the dependency information corresponds to a common application executed by each of the first UE and the second UE, and wherein the application generates multi-modal data including the first data flow and the second data flow.

Example 18 includes the method of example 17, wherein the multi-modal data is directed to a plurality of UEs in the device group that each execute the application, the plurality of UEs including the first UE and the second UE.

Example 19 includes a method performed by a base station, the method including: transmitting, to a plurality of user equipments (UEs), group assignment configuration information indicating a plurality of radio resource assignment parameters respectively dedicated to the plurality of UEs; assigning the plurality of UEs to a device group; transmitting, to the plurality of UEs in the device group, a group assignment message; and causing the plurality of UEs to communicate with the base station based at least on the plurality of radio resource assignment parameters.

Example 20 includes the method of example 19, wherein the group assignment message includes one or more common radio resource assignment parameters that are common to the plurality of UEs in the device group, and wherein the group assignment message causes the plurality of UEs to communicate with the base station based on the one or more common radio resource assignment parameters.

Example 21 includes the method of example 19, further including: transmitting, to the plurality of UEs in the device group and separately from the group assignment message, a plurality of dynamic radio resource assignment parameters respectively dedicated to the plurality of UEs; and causing the plurality of UEs to communicate with the base station based at least on the plurality of dynamic radio resource assignment parameters and the plurality of radio resource assignment parameters.

Example 22 includes the method of example 21, further including: causing the plurality of UEs to derive the plurality of dynamic radio resource assignment parameters according to the group assignment configuration information.

Example 23 includes the method of example 19, further including: determining that the plurality of UEs have pending data on a plurality of radio bearers with a same quality of service (QoS) requirement; and grouping the plurality of UEs in the device group in response to the determining.

Example 24 includes the method of example 19, further including transmitting, to the plurality of UEs, an identifier of the device group, wherein the identifier include a radio network temporary identifier (RNTI).

Example 25 includes the method of example 19, wherein assigning the plurality of UEs to the device group is via at least one of: a radio resource control (RRC) message, a layer 2 (L2) medium access control (MAC) control element (CE), or a layer 1 (L1) message.

Example 26 includes the method of example 19, wherein the one or more radio resource assignment parameters include one or more common parameters that are applicable to the plurality of UEs in the device group and one or more UE-specific parameters.

Example 27 includes a method performed by a user equipment (UE), the method including: receiving group assignment configuration information from a base station, wherein the group assignment configuration information indicates one or more radio resource assignment parameters; receiving a grouping message from the base station, wherein the grouping message assigns the UE to a device group including one or more other UEs, and wherein the grouping message associates the UE with the one or more radio resource assignment parameters; receiving a group assignment message from the base station; and in response to the group assignment message, communicating with the base station based at least on the one or more radio resource assignment parameters.

Example 28 includes the method of example 27, wherein the group assignment message includes one or more common radio resource assignment parameters that are common to the UE and the one or more other UEs in the device group.

Example 29 includes the method of example 27, further including: receiving, from the base station and in response to the group assignment message, one or more dynamic radio resource assignment parameters dedicated to the UE.

Example 30 includes the method of example 29, wherein communicating with the base station is further based at least on the one or more dynamic radio resource assignment parameters.

Example 31 includes the method of example 30, further including: determining whether to overwrite the one or more radio resource assignment parameters indicated by the group assignment configuration information with the one or more dynamic radio resource assignment parameters.

Example 32 includes the method of example 29, further including: deriving the one or more dynamic radio resource assignment parameters based on the group assignment configuration information.

Example 33 includes the method of example 32, wherein deriving the one or more dynamic radio resource assignment parameters includes: determining, from the group assignment configuration information, an index of the UE in the device group; and determining, based on the index of the UE, a radio resource start offset associated with the UE, wherein communicating with the base station is according to the radio resource start offset.

Example 34 includes the method of example 27, further including indicating, to the base station via radio resource control (RRC) signaling, that the UE supports group assignment.

Example 35 includes the method of example 27, further including transmitting, to the base station, a request for being scheduled as part of the device group.

Example 36 includes the method of example 27, wherein the group assignment configuration information is first group assignment configuration information that indicates the UE is assigned to a first device group, and wherein the method further includes: receiving second group assignment configuration information from the base station, the second group assignment configuration information indicating that the UE is assigned to a second device group; and receiving an instruction to communicate with the base station as part of the first device group using the first group assignment configuration information.

Example 37 includes the method of example 36, further including: receiving a switching instruction to dynamically switch from the first device group to the second device group.

Example 38 includes the method of example 27, wherein the group assignment configuration information includes a plurality of configuration sets, and wherein the method further includes receiving, from the base station, a selection instruction that indicates a configuration set to use for communicating with the base station in the device group.

Example 39 includes the method of example 27, wherein the group assignment configuration information includes the grouping message.

Example 40 includes the method of example 27, further including receiving a removal message that removes the UE from the device group.

Example 41 includes the method of example 27, wherein communicating with the base station includes: in response to determining that the UE has pending uplink data, transmitting the uplink data; and in response to determining that the UE does not have pending uplink data, skipping an uplink transmission.

Example 42 includes the method of example 27, wherein the one or more radio resource assignment parameters include one or more common parameters that are applicable all UEs in the device group and one or more UE-specific parameters.

Example 43 includes one or more processors including circuitry configured to execute instructions that cause a communication apparatus to perform the method of any of examples 1-42.

Example 44 includes a communication apparatus including one or more processors configured to perform the method of any of examples 1-42.

Example 45 includes a non-transitory computer-readable medium storing program instructions that, when executed, cause one or more processors to perform the method of any of examples 1-42.

Example 46 may include one or more non-transitory computer-readable media including instructions to cause an electronic device, upon execution of the instructions by one or more processors of the electronic device, to perform one or more elements of a method described in or related to any of examples 1-42, or any other method or process described herein.

Example 47 may include an apparatus including logic, modules, or circuitry to perform one or more elements of a method described in or related to any of examples 1-42, or any other method or process described herein.

Example 48 may include a method, technique, or process as described in or related to any of examples 1-42, or portions or parts thereof.

Example 49 may include an apparatus including: one or more processors and one or more computer-readable media including instructions that, when executed by the one or more processors, cause the one or more processors to perform the method, techniques, or process as described in or related to any of examples 1-42, or portions thereof.

Example 50 may include a signal as described in or related to any of examples 1-42, or portions or parts thereof.

Example 51 may include a datagram, information element, packet, frame, segment, PDU, or message as described in or related to any of examples 1-42, or portions or parts thereof, or otherwise described in the present disclosure.

Example 52 may include a signal encoded with data as described in or related to any of examples 1-42, or portions or parts thereof, or otherwise described in the present disclosure.

Example 53 may include a signal encoded with a datagram, IE, packet, frame, segment, PDU, or message as described in or related to any of examples 1-42, or portions or parts thereof, or otherwise described in the present disclosure.

Example 54 may include an electromagnetic signal carrying computer-readable instructions, wherein execution of the computer-readable instructions by one or more processors is to cause the one or more processors to perform the method, techniques, or process as described in or related to any of examples 1-42, or portions thereof.

Example 55 may include a computer program including instructions, wherein execution of the program by a processing element is to cause the processing element to carry out the method, techniques, or process as described in or related to any of examples 1-42, or portions thereof. The operations or actions performed by the instructions executed by the processing element can include the methods of any one of examples 1-42.

Example 56 may include a signal in a wireless network as shown and described herein.

Example 57 may include a method of communicating in a wireless network as shown and described herein.

Example 58 may include a system for providing wireless communication as shown and described herein. The operations or actions performed by the system can include the methods of any one of examples 1-42.

Example 59 may include a device for providing wireless communication as shown and described herein. The operations or actions performed by the device can include the methods of any one of examples 1-42.

The previously-described examples 1-42 are implementable using a computer-implemented method; a non-transitory, computer-readable medium storing computer-readable instructions to perform the computer-implemented method; and a computer system including a computer memory interoperably coupled with a hardware processor configured to perform the computer-implemented method or the instructions stored on the non-transitory, computer-readable medium.

A system, e.g., a base station, an apparatus including one or more baseband processors, and so forth, can be configured to perform particular operations or actions by virtue of having software, firmware, hardware, or a combination of them installed on the system that in operation causes or cause the system to perform the actions. The operations or actions performed either by the system can include the methods of any one of examples 1-42.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

What is claimed is:

1. A method comprising:
receiving one or more requests to register a first user equipment (UE) and a second UE in a device group, wherein the device group corresponds to a common application executed by the first UE and the second UE;
obtaining, from the one or more requests, information about a plurality of UEs in the device group and a plurality of data flows corresponding to the plurality of UEs in the device group, the information comprising dependency information between a first data flow and a second data flow of the plurality of data flows; and
sending, to a base station, instructions to configure the device group, wherein the instructions comprise scheduling information for the first UE and the second UE, and wherein the scheduling information is based at least on the dependency information.

2. The method of claim 1, wherein the first data flow and the second data flow both correspond to the first UE.

3. The method of claim 1, wherein the first data flow and the second data flow correspond to the first UE and the second UE, respectively.

4. The method of claim 3,
wherein sending the instructions to configure the device group comprises determining, based on the dependency information between the first data flow and the second data flow, a timing constraint between the first data flow and the second data flow, and
wherein the scheduling information for the first UE and the second UE is based at least on the timing constraint.

5. The method of claim 4, wherein determining the timing constraint is based on determining a processing capability of at least one of the first UE or the second UE.

6. The method of claim 4, further comprising: instructing the base station to transmit the first data flow and the second data flow to the first UE and the second UE, respectively, according to the timing constraint.

7. The method of claim 4, wherein the timing constraint comprises a time window characterized by a maximum time difference between a first time at which the first UE receives data corresponding to the first data flow and a second time at which the second UE receives data corresponding to the second data flow during a specified time period.

8. The method of claim 4, further comprising determining the scheduling information based on at least one of: delay measurement results reported by the first UE and the second UE, vicinity measurement results reported by the first UE and the second UE, or quasi-colocation (QCL) information between the first UE and the second UE.

9. The method of claim 4, wherein the instructions further comprise at least one of: an identifier of the device group, priority information of the plurality of data flows, one or more policies for scheduling failure, or one or more UE reporting configurations.

10. The method of claim 1, further comprising:
instructing a session management function (SMF) to establish a plurality of PDU sessions with the device group, wherein the plurality of PDU sessions comprise a first PDU session corresponding to the first data flow and a second PDU session corresponding to the second data flow.

11. The method of claim 1, further comprising:
receiving, from the plurality of UEs, a request to establish a group protocol data unit (PDU) session; and
instructing a session management function (SMF) to establish the group PDU session with the device group,
wherein the group PDU session comprises one or more member PDU sessions.

12. The method of claim 11, wherein the first data flow and the second data flow are transmitted in a same member PDU session of the one or more PDU sessions.

13. A method comprising:
receiving one or more requests to register a first user equipment (UE) and a second UE in a device group;
obtaining, from the one or more requests, information about a first data flow and a second data flow, wherein the first data flow and the second data flow are associated with communication in the device group;
determining a timing constraint corresponding to the device group based on the first data flow and the second data flow, wherein the timing constraint is applied between packets the first data flow and the second data flow, packet bursts of the first data flow and the second data flow, or protocol data unit (PDU) sets of the first data flow and the second data flow;
scheduling the first data flow and the second data flow based on the timing constraint; and
controlling transmission of the first data flow and the second data flow (i) to the first UE and the second UE, respectively, or (ii) both to the first UE, according to the scheduling.

14. The method of claim 13, wherein the information about the first data flow and the second data flow comprises dependency information between the first data flow and the second data flow.

15. The method of claim 14,
wherein the first data flow and the second data flow correspond to the first UE and the second UE, respectively, and
wherein determining the timing constraint comprises: determining, based on the dependency information, a time window characterized by a maximum time difference between a first time at which the first UE receives data corresponding to the first data flow and a second time at which the second UE receives data corresponding to the second data flow during a specified time period.

16. A method comprising:
obtaining, from at least one of a first user equipment (UE) and a second UE, dependency information between a first data flow to be received by the first UE and a second data flow to be received by the second UE;
transmitting, to a base station, a request to register the first UE and the second UE in a device group, wherein the request comprises the dependency information;
receiving, from the base station, a configuration of the device group, the configuration comprising a timing constraint between the first data flow and the second data flow based at least on the dependency information;
scheduling, based on the timing constraint, transmission of the first data flow and the second data flow; and
controlling, according to the scheduling, the transmission of the first data flow and the second data flow to the first UE and the second UE, respectively.

17. The method of claim 16, wherein the dependency information corresponds to a common application executed by each of the first UE and the second UE.

18. The method of claim 17, wherein the application generates multi-modal data including the first data flow and the second data flow.

19. The method of claim 18, wherein the multi-modal data is directed to a plurality of UEs in the device group that each execute the application, the plurality of UEs including the first UE and the second UE.

20. The method of claim 16, further comprising:
determining the timing constraint by determining, based on the dependency information, a time window characterized by a maximum time difference between a first time at which the first UE receives data corresponding to the first data flow and a second time at which the second UE receives data corresponding to the second data flow during a specified time period.
